(19) United States
(12) Patent Application Publication
(10) Pub. No.: US 2025/0117126 A1
(43) Pub. Date: Apr. 10, 2025

(54) MEDIA CONTENT ITEM PROCESSING BASED ON USER INPUTS

(71) Applicant: ADOBE INC., SAN JOSE, CA (US)

(72) Inventors: Ajinkya Gorakhnath Kale, San Jose, CA (US); Alvin Ghouas, Oppegård (NO); Baldo Faieta, San Francisco, CA (US); Evan Benjamin Shimizu, San Mateo, CA (US); Jeremy Jay Joachim, Shrewsbury, MA (US); Tomasz Opasinski, Tujunga, CA (US)

(21) Appl. No.: 18/904,517

(22) Filed: Oct. 2, 2024

Related U.S. Application Data
(60) Provisional application No. 63/588,027, filed on Oct. 5, 2023.

(51) Int. Cl. G06F 3/04847; G06F 3/0486; G06F 16/43; G06T 11/00

(52) U.S. Cl. CPC G06F 3/04847; G06F 3/0486; G06F 16/43; G06T 11/00; G06T 2200/24

(57) ABSTRACT

A method, apparatus, non-transitory computer readable medium, and system for media processing includes obtaining a variation parameter and a number of variations, identifying a first variation input and a second variation input for the variation parameter, and obtaining a first media content item and a second media content item based on the first variation input and the second variation input, respectively. The first media content item and the second media content item vary from each other with respect to the variation parameter. The method, apparatus, non-transitory computer readable medium, and system for media processing further includes displaying the first media content item and the second media content item in a grid comprising a grid size based on the number of variations.

### CROSS-REFERENCE TO RELATED APPLICATION

This application claims priority under 35 U.S.C. § 119 to U.S. Provisional Application No. 63/588,027, filed on Oct. 5, 2023, in the United States Patent and Trademark Office, the disclosure of which is incorporated by reference herein in its entirety.

### BACKGROUND

Media such as images, audio, video, and text can be generated and modified both algorithmically and by using machine learning. In an example, a user can generate an image by providing a text prompt describing content of an image to a machine learning model, and the machine learning model can generate the image based on the text prompt. In another example, a user can adjust an input parameter with respect to an existing image, and an algorithm can modify the existing image based on the adjusted input parameter.

### SUMMARY

Embodiments of the present disclosure provide systems and processes for intuitively obtaining a set of media content items and displaying the set of media content items in a user-friendly manner. In some cases, a computing apparatus provides a user interface that accepts intuitive user inputs (such as contextual drop-down menu selections and drag-and-drop inputs) to adjust a media content item variation parameter that is used as an input for generating or retrieving a set of media content items based on the variation parameter. In some cases, a selected number of created or retrieved media content items is displayed in a grid. One or more of the media content items, corresponding variation parameters, or a combination thereof can be saved by the user for ease of reference and collaboration with other users.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a media content system according to aspects of the present disclosure.

FIG. 2 shows an example of a method for providing a new media content item according to aspects of the present disclosure.

FIG. 3 shows an example of media content items according to aspects of the present disclosure.

FIG. 4 shows an example of a guided diffusion model according to aspects of the present disclosure.

FIG. 5 shows an example of a U-Net according to aspects of the present disclosure.

FIG. 6 shows an example of a method for displaying media content items according to aspects of the present disclosure.

FIG. 7 shows an example of a method for displaying generated media content items according to aspects of the present disclosure.

FIG. 8 shows an example of a method for conditional image generation according to aspects of the present disclosure.

FIG. 9 shows an example of a diffusion process according to aspects of the present disclosure.

FIGS. 10 through 15 show an example of generating additional media content items according to aspects of the present disclosure.

FIG. 16 shows an example of replacing words in a text prompt using a variation handle according to aspects of the present disclosure.

FIGS. 17 through 19 show an example of generating additional media content items using a parameter stepper tool according to aspects of the present disclosure.

FIG. 20 shows an example of varying image generation iterations using a parameter stepper tool according to aspects of the present disclosure.

FIGS. 21 through 22 show an example of generating additional media content items using modifier presets according to aspects of the present disclosure.

FIGS. 23 through 24 show an example of creating additional media content items based on a media content item using modifier presets according to aspects of the present disclosure.

FIG. 25 shows an example of creating a set of media content items using a set of text prompt presets according to aspects of the present disclosure.

FIG. 26 shows an example of creating a set of additional content media items by applying a set of text prompt presets to a content media item according to aspects of the present disclosure.

FIG. 27 shows an example of a flow diagram depicting an algorithm as a step-by-step procedure for training a machine learning model according to aspects of the present disclosure.

FIG. 28 shows an example of a method for training a diffusion model according to aspects of the present disclosure.

FIG. 29 shows an example of a computing device according to aspects of the present disclosure.

FIG. 30 shows an example of a computing apparatus according to aspects of the present disclosure.

### DETAILED DESCRIPTION

### Overview

Media such as images, audio, video, and text can be generated and modified both algorithmically and by using machine learning. In an example, a user can generate an image by providing a text prompt describing content of an image to a machine learning model, and the machine learning model can generate the image based on the text prompt. In another example, a user can adjust an input parameter with respect to an existing image, and an algorithm can modify the existing image based on the adjusted input parameter.

However, existing systems and methods for media creation and modification may not provide intuitive user interfaces. For example, in an image generation context, users may have difficulty generating image variations, generating a variety of styles that the user is actively exploring, organizing and collecting generated images (such as by saving “favorites”), figuring out what some technical parameters do, and accessing and combining additional control modalities such as depth reference images. Furthermore, users may not be able to easily compare differences between generated images.

Accordingly, embodiments of the present disclosure provide systems and processes for intuitively creating or retrieving a set of media content items and displaying the set of media content items in a user-friendly manner. In some cases, a computing apparatus provides a user interface that accepts intuitive user inputs (such as contextual drop-down menu selections and drag-and-drop inputs) to adjust a media content item variation parameter that is used as an input for generating or retrieving a set of media content items based on the variation parameter. In some cases, a selected number of created or retrieved media content items is displayed in a grid. In some cases, one or more of the media content items, corresponding variation parameters, or a combination thereof can be saved by the user for ease of reference and collaboration with other users.

According to some aspects, a design board (e.g., an infinite canvas) is provided via a user interface, where the design board facilitates rapid generation and iteration of media content items (such as generated images). The user interface may provide design board features such as a camera that can be panned and zoomed and tiles that persist on the design board in user-specified locations. A user may generate a media content item by providing a prompt, where the media content item is displayed in a tile on the design board.

According to some aspects, a variation handle interface is displayed. A user may click and drag the variation handle to cause a set of tiles to appear in an area defined by a rectangle created by a center of a selected tile and a location of the dragged variation handle. The tiles may display information relevant to a current variation mode (such as a seed variation mode, a word replacement mode, a style mode, etc.). In an example, each of the tiles display a seed number, a replaced word, a style, etc. that will be used as input for creating a corresponding media content item. Once the user has created a desired grid of tiles, they may release the mouse button to instruct the computing apparatus to generate and display media content items according to the variation mode and the selected variation parameters. The variation handle may operate based on single selections, multiple selections, or a combination thereof. In at least one embodiment, when used with multiple selections, the variation handle operates on a single axis (e.g., horizontal or vertical) and applies same settings across rows or columns of the design board.

According to some aspects, a parameter stepper interface is displayed. The parameter stepper interface may be applied to parameters having associated numerical values (such as seeds, style mixes, generation iteration counts, color values, etc.) that can be incremented or stepped. When the user selects a media content item and the applicable variation mode, the parameter stepper interface may appear adjacent to the selected media content item. In some embodiments, the parameter stepper interface includes a slider that allows the numerical value to be adjusted. In response to generating and displaying a media content item based on the parameter stepper interface, a viewport of the design board may move to a center of the generated media content item. The user may then continue to step along the range of parameter values.

According to some aspects, a modifier list can be dragged onto a tile from a window on the bottom of the screen or selected from a dropdown item when a tile is selected. When applied to a tile, additional tiles may be displayed adjacent to the tile, with text describing a modification to be made displayed on each additional tile. In some embodiments, when the user provides a “generate” input, media content items are generated and displayed in corresponding additional tiles according to the modifier list's rules. A modifier list may be used to quickly apply multiple styles to a selected tile or media content item.

According to some aspects, each operation with a different variation control generates a new media content item in a new tile, thereby providing a non-linear, non-destructive editing interface. Accordingly, a quality of a user experience of creating media content items may be dramatically increased.

Aspects of the present disclosure can be used in an image generation context. For example, tools provided by a user interface allow a user to intuitively provide various input parameters to a computing apparatus, and the computing apparatus generates one or more images based on the input parameters (for example, using a generative algorithm or machine learning model).

In an example, a user provides a text prompt describing image content to a user interface provided on a user device by the computing apparatus. The computing apparatus generates an image based on the text prompt and displays the image in a grid of the user interface. The user wants to generate a set of similar but randomized images, and so selects a “seed” variation mode from the user interface, in which a seed (e.g., a numerical image generation input parameter) will be a variation parameter.

In response to the selection, the user interface displays a pull handle connected to the image. The user clicks on the pull handle, drags the handle across seven sections of the grid, and releases the handle, thereby indicating, in an intuitive and user-friendly manner, that seven additional images should be generated based on the text prompt and seven random seeds. The computing apparatus generates seven additional images based on the text prompt and a corresponding random seed and displays the seven additional images in the grid.

Aspects of the present disclosure can be used in a media content item retrieval process. For example, tools provided by a user interface allow a user to intuitively provide various input search parameters to a computing apparatus, and the computing apparatus retrieves one or more media content items based on the input search parameters (for example, from a database, the Internet, etc.).

In an example, a user provides a text search query “a dog in a park” for an image to the user interface, and the computing apparatus retrieves and displays an image matching the text search query from a database. The user decides that they also want to retrieve a set of random images based on the text search query. The user selects a “randomize query” mode from a menu displayed by the user interface and chooses the words “dog” and “park” to be randomized. In response to the selection of the “randomize query” mode, the user interface displays a pull handle attached to the image.

The user drags the handle across 15 sections of the grid. Each of the 15 sections of the grid displays two words that are respectively chosen by the computing apparatus to replace “dog” and “park” (e.g., “pug” and “bench”, respectively). The user releases the handle, and the computing apparatus retrieves and displays 15 additional images corresponding to the 15 modified text search queries. The user interface displays the 15 retrieved images in the grid in their respective sections.

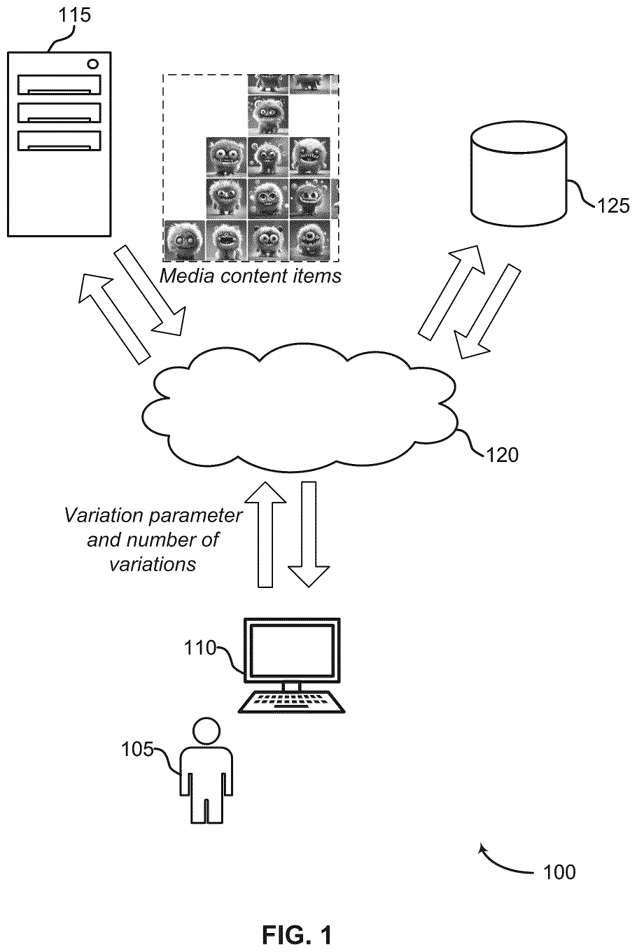

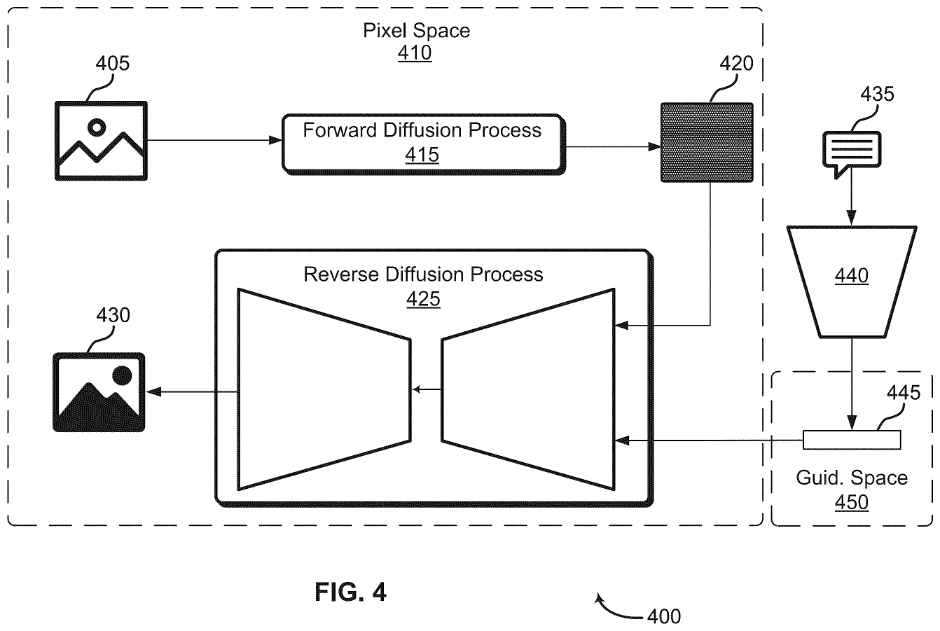

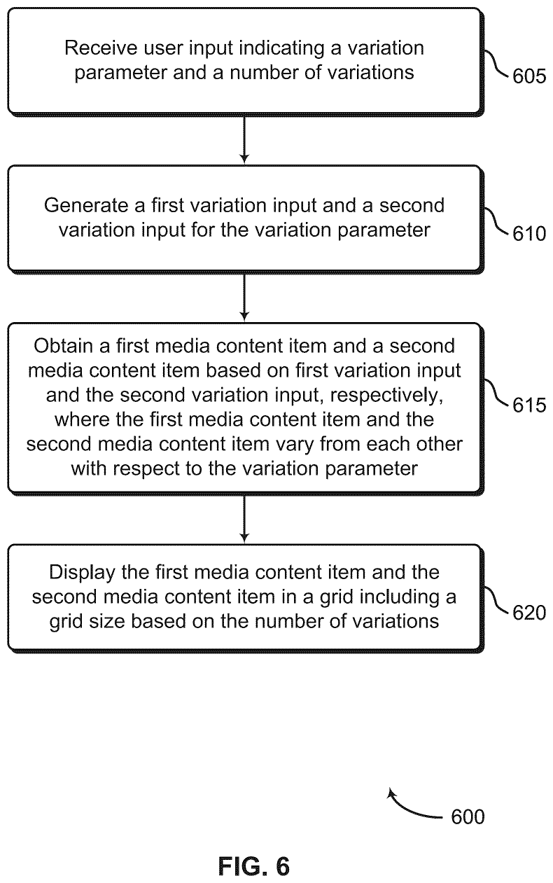

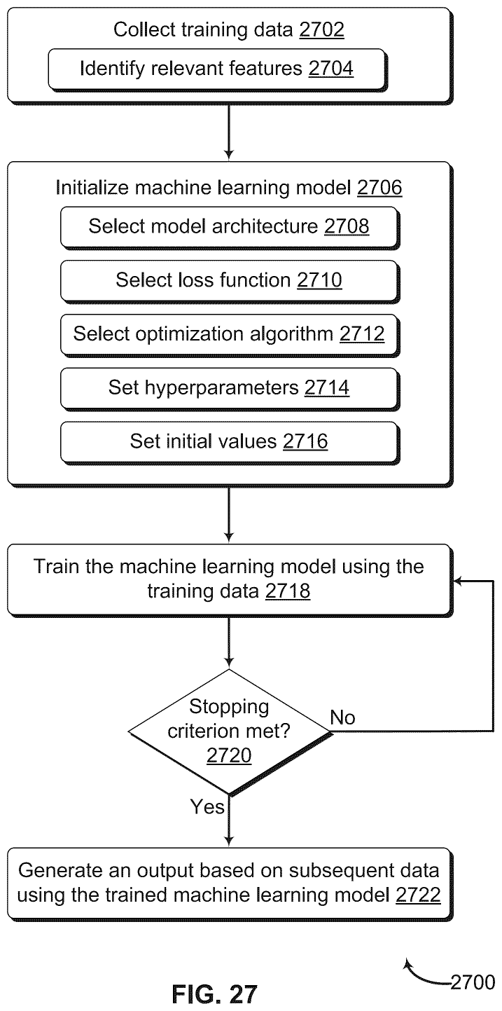

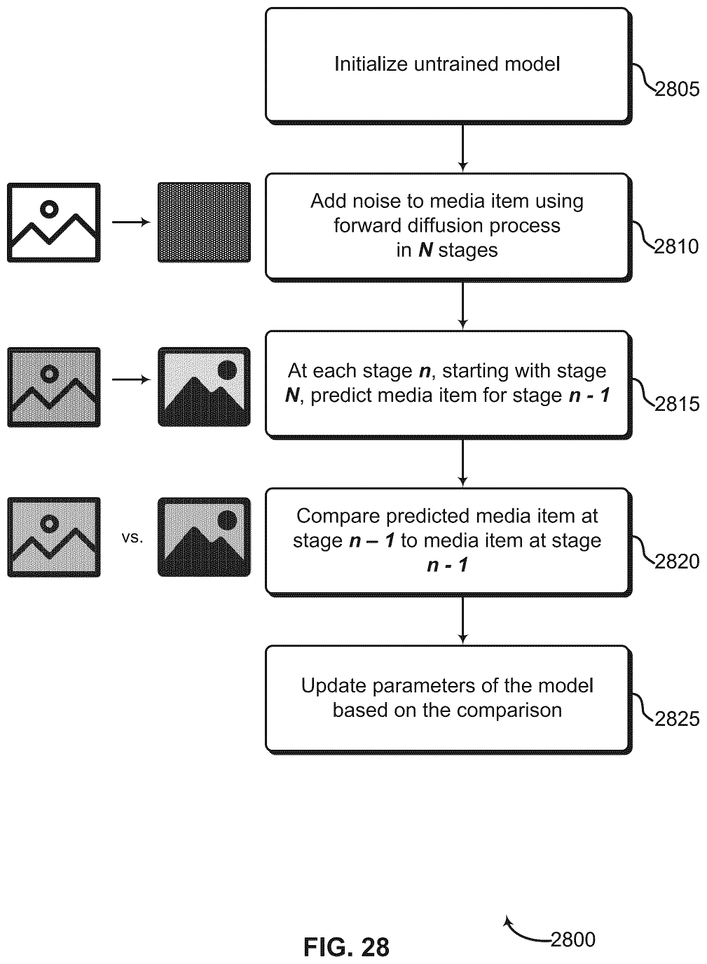

Further example contextual applications of the present disclosure are provided with reference to FIGS. 1-3 and 10-26. Details regarding the architecture of a media content system are provided with reference to FIGS. 4-5 and 29-30. Examples of process for media content item processing are described with reference to FIGS. 6-26. Examples of a process for training a machine learning model are provided with reference to FIGS. 27-28.

Embodiments of the present disclosure improve upon conventional media processing systems by emphasizing media content item variation through non-textual means. For example, according to aspects of the present disclosure, a media content system obtains a user input including a variation parameter and a number of variations and generates a set of variation inputs based on the variation parameter. The media content system can then obtain and display a set of media content items based on the generated variation inputs, where the set of media content items vary from each other with respect to the variation parameter, and the number of media content items corresponds to the number of variations. By contrast, conventional methods of media processing rely on precise user instructions to produce intended outputs without undue experimentation.

Therefore, according to some aspects, the media content system displays various media content items with speed and ease by offering an intuitive user interface for a user selection of parameter variations, where the various media content items are obtained based on the parameter variations. Accordingly, unlike in conventional media processing systems, a user knowledge of a function associated with a parameter variation is not needed, thereby allowing any user of any skill level to obtain varied media content items using the media content system. In some cases, as a generation of new media content items is a non-destructive operation, a user can easily backtrack and explore other media content item variations based on their history. In some cases, favorites can be marked, providing another method of retaining and sharing a design history.

### Example Media Content System

FIG. 1 shows an example of a media content system 100 according to aspects of the present disclosure. The example shown includes media content system 100, user 105, user device 110, computing apparatus 115, cloud 120, and database 125.

Referring to FIG. 1, user 105 provides a user input indicating a variation parameter and a number of variations to computing apparatus 115 via a user interface provided on user device 110 by computing apparatus 115. Computing apparatus 115 generates a set of variation inputs based on the variation parameter and obtains a set of media content items corresponding to the number of variations and the variation inputs, where the set of media content items differ from each other with respect to the variation parameter. Computing apparatus 115 displays the set of media content items in a grid of a design board via the user interface, where a number of columns or rows of the grid corresponds to the number of variations.

A “media content item” refers to an item of media content, such as an image, an audio file, a video file, a text file, etc. In some cases, a media content item includes a visual representation of non-visual media (such as an audio file). In some cases, the visual representation allows a user to interact with the non-visual media content item (such as playing a corresponding audio file).

A “variation parameter” refers to a parameter having a value that can be altered via a user input. A “variation input” refers to an input generated based on the variation parameter. In some cases, a variation input is provided as an input to an algorithm or a machine learning model, and an output of the algorithm or the machine learning model is based on the variation input.

A “design board” refers to an area of a user interface for displaying information corresponding to one or more media content items. In some cases, a design board includes one or more tiles. A “tile” refers to an area or section of a design board that displays text corresponding to a variation parameter and/or a value of a variation parameter, text corresponding to a stage of a content retrieval or generation process (e.g., “generating”, “searching”, “processing”, etc.), a user interface element corresponding to the variation parameter, or a media content item. An “infinite canvas” refers to a design board that extends without a predefined limit in one or more of a horizontal direction and a vertical direction.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface, a text-based user interface, or a combination thereof) provided by computing apparatus 115. The user interface allows information to be communicated between user 105 and computing apparatus 115.

According to some aspects, a user device user interface enables user 105 to interact with user device 110. The user device user interface may include an audio device, such as an external speaker system, an external display device such as a display screen, or an input device (e.g., a remote-control device interfaced with the user interface directly or through an I/O controller module). The user device user interface may be a graphical user interface, a text-based interface, or a combination thereof.

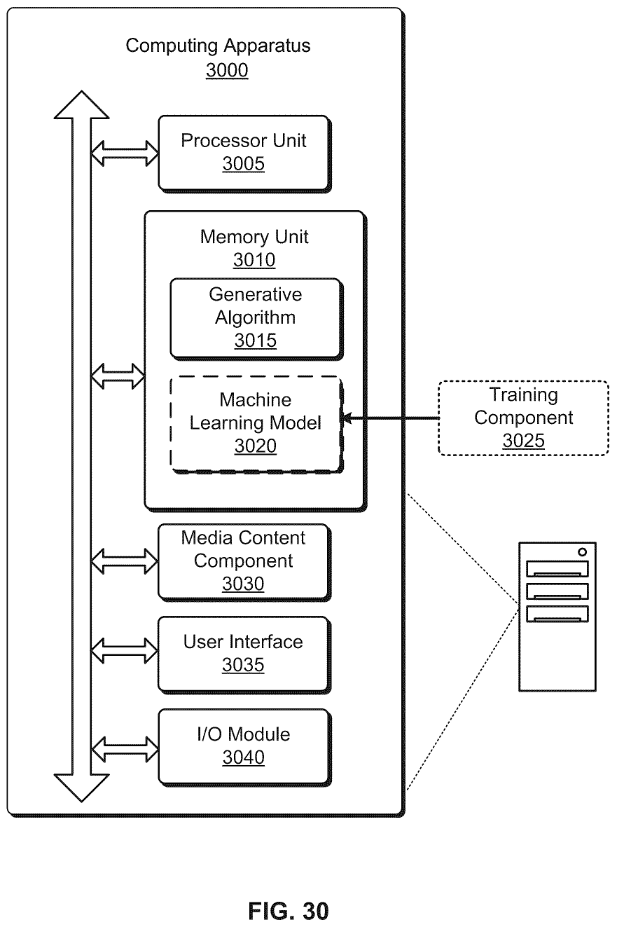

Computing apparatus 115 is an example of, or includes aspects of, the corresponding element described with reference to FIG. 30. According to some aspects, computing apparatus 115 includes a computer-implemented network. In some embodiments, the computer-implemented network includes a machine learning model (such as the machine learning model described with reference to FIG. 30).

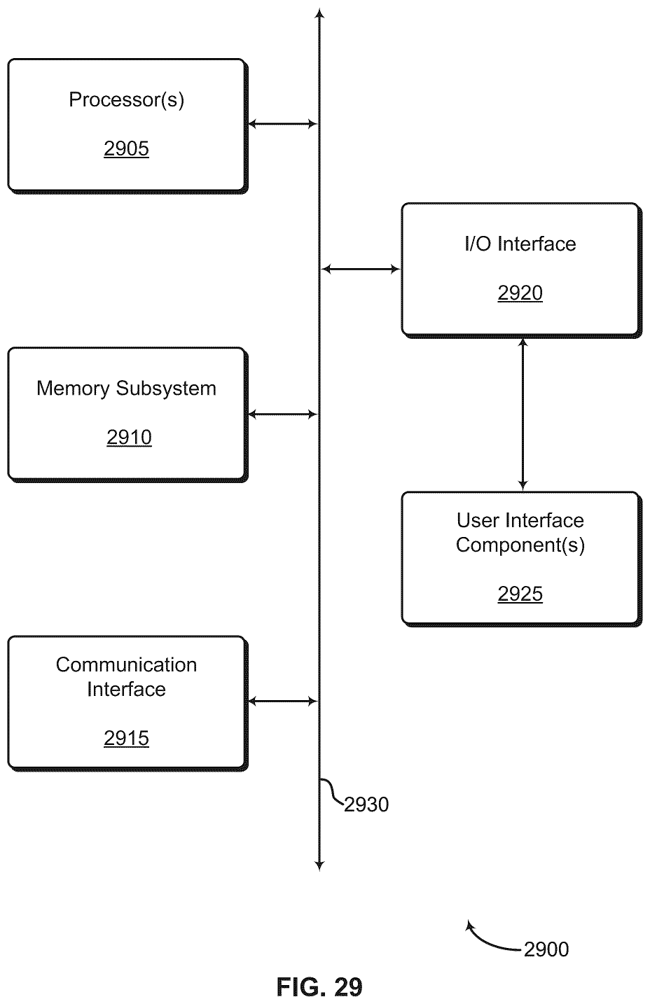

Computing apparatus 115 may also include one or more processors, a memory subsystem, a communication interface, an I/O interface, one or more user interface components, and a bus as described with reference to FIG. 29. Additionally, computing apparatus 115 may communicate with user device 110 and database 125 via cloud 120.

Computing apparatus 115 may be implemented on a server. A server provides one or more functions to users linked by way of one or more of various networks, such as cloud 120. The server includes one or more microprocessor boards which include microprocessors responsible for controlling all aspects of the server. The server may use microprocessor(s) and protocols such as hypertext transfer protocol (HTTP), simple mail transfer protocol (SMTP), file transfer protocol (FTP), and/or simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

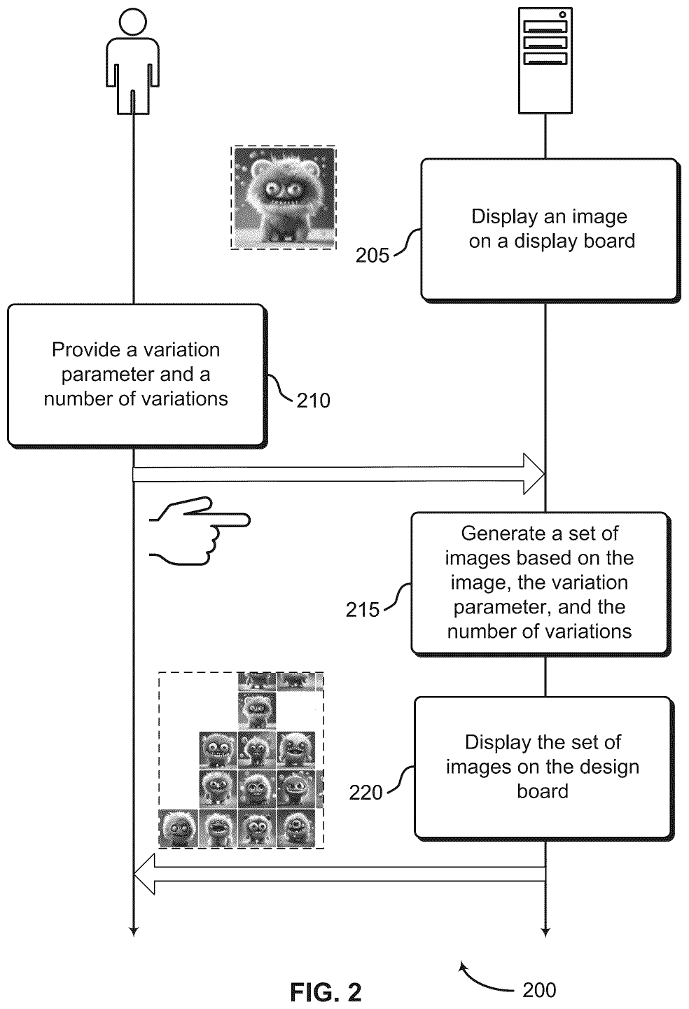

Further detail regarding the architecture of computing apparatus 115 is provided with reference to FIGS. 4-5 and 29-30. Further detail regarding a process for retrieving/generating and displaying media content items is provided with reference to FIGS. 2-3 and 6-26. Further detail regarding a process for training a machine learning model is provided with reference to FIGS. 27-28.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, computing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in computing apparatus 115. According to some aspects, database 125 is external to computing apparatus 115 and communicates with computing apparatus 115 via cloud 120.

FIG. 2 shows an example of a method 200 providing a new media content item according to aspects of the present disclosure. Referring to FIG. 2, an aspect of the present disclosure is used to generate image variations for a user. For example, the media content system displays an original image on a design board of a user interface provided by the media content system on a user device. The user provides a variation parameter (such as a seed) to the user interface, and indicates a number of variations (e.g., a number of images that differ by each other with respect to the variation parameter). The media content system generates a set of variation inputs (e.g., a set of random seeds) based on the variation parameter. The media content system generates a set of images including the number of different images based on the original image and the corresponding set of variation inputs and displays the set of images to the user on the design board.

At operation 205, the system displays an image on a display board. In some cases, the operations of this step refer to, or may be performed by, a computing apparatus as described with reference to FIGS. 1 and 30. For example, a user interface of the computing apparatus displays the image on the display board via a user device (such as the user device described with reference to FIG. 1) as described with reference to FIGS. 6-26. The computing apparatus may obtain the image from a user. The computing apparatus may generate the image (e.g., randomly or based on a prompt). The computing apparatus may retrieve the image (e.g., randomly or based on a search query) from a database (such as the database described with reference to FIG. 1) or from another data source (such as the Internet).

At operation 210, a user provides a variation parameter and a number of variations. In some cases, the operations of this step refer to, or may be performed by, a user as described with reference to FIG. 1. For example, the user provides the variation parameter and the number of variations as described with reference to FIGS. 6-26. In an example, the variation parameter is a seed parameter. The user provides the seed parameter by selecting “seed” from a drop-down menu displayed by the user interface. The user provides the number of variations by dragging a user interface handle a distance away from the image, where as the distance increases, the number of variations increases.

At operation 215, the system generates a set of images based on the image, the variation parameter, and the number of variations. In some cases, the operations of this step refer to, or may be performed by, a computing apparatus as described with reference to FIGS. 1 and 30. For example, the computing apparatus generates the set of images as described with reference to FIGS. 6-26.

In an example, the computing apparatus generates a set of random seeds (e.g., variation inputs), where the number of random seeds is equal to the number of variations. In some embodiments, the computing apparatus generates the set of images using a machine learning model comprising an image generation model, where the image generation model takes the image (or a vector representation of the image, or a prompt corresponding to the image, or a vector representation of the prompt), the set of random seeds, and the number of variations as input, and generates a set of images as output. Each image of the set of images is generated based on the image and a respective random seed of the set of random seeds.

At operation 220, the system displays the set of images on the design board. In some cases, the operations of this step refer to, or may be performed by, a computing apparatus as described with reference to FIGS. 1 and 30. In an example, the computing apparatus displays the set of images in a grid including a number of rows and columns based on the number of variations.

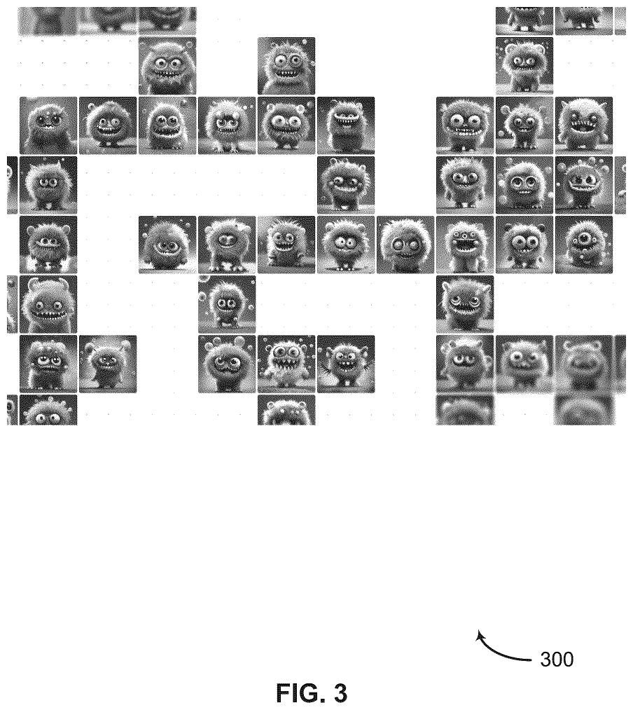

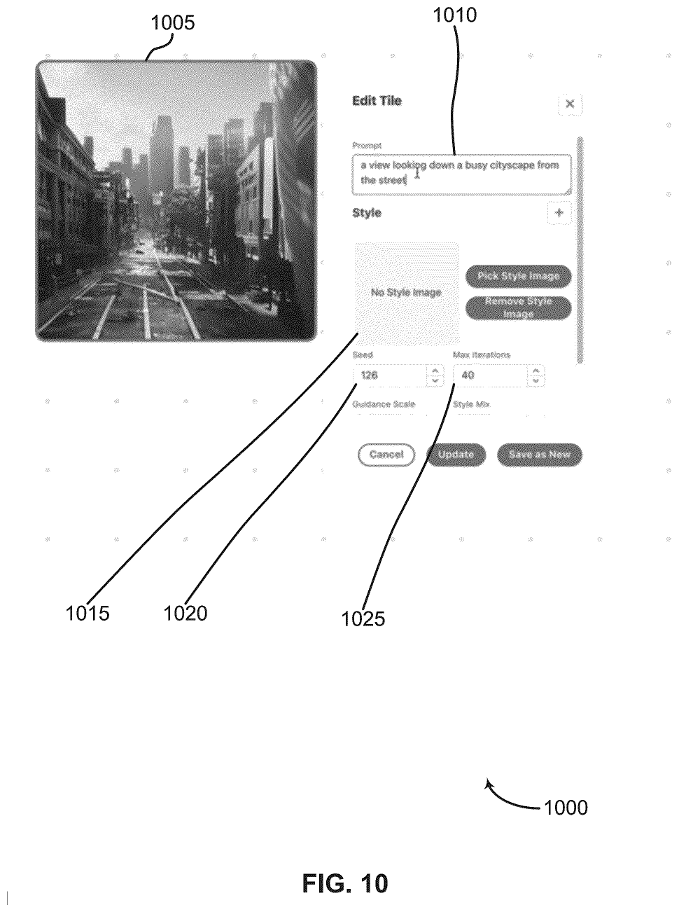

FIG. 3 shows an example of media content items displayed on a design board 300 according to aspects of the present disclosure. Design board 300 is an example of, or includes aspects of, the corresponding element described with reference to FIGS. 10-26. Referring to FIG. 3, a design board (such as design board 300) displays various media content items (in the example of FIG. 3, images) generated and/or retrieved according to variation inputs generated based on a variation parameter provided by a user. In the example of FIG. 3, each of the displayed images are generated based on an original image, a seed parameter provided by the user, and a random seed of a generated set of random seeds. As shown in FIG. 3, design board 300 includes a grid of regularly spaced background dots as a visual aid for orienting displayed media content items.

FIG. 4 shows an example of a guided diffusion model 400 according to aspects of the present disclosure. In some examples, guided diffusion model 400 describes the operation and architecture of the machine generation model 3020 described with reference to FIG. 30. The guided diffusion model 400 depicted in FIG. 4 is an example of, or includes aspects of, an image generation model comprised in a machine learning model as described herein (such as the machine learning model 3020 described with reference to FIG. 30).

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Diffusion models work by iteratively adding noise to the data during a forward process and then learning to recover the data by denoising the data during a reverse process. For example, during training, guided latent diffusion model 400 may take an original image 405 in a pixel space 410 as input and apply forward diffusion process 415 to gradually add noise to the original image 405 to obtain noisy images 420 at various noise levels.

Next, a reverse diffusion process 425 (e.g., implemented by a U-Net) gradually removes the noise from the noisy images 420 at the various noise levels to obtain an output image 430. In some cases, an output image 430 is created from each of the various noise levels. The output image 430 can be compared to the original image 405 to train the reverse diffusion process 425.

The reverse diffusion process 425 can also be guided based on a text prompt 435, or another guidance prompt, such as a variation input, an image, a layout, a segmentation map, a seed, etc. The text prompt 435 can be encoded using a text encoder 440 (e.g., a multimodal encoder) to obtain guidance features 445 in guidance space 450. The guidance features 445 can be combined with the noisy images 420 at one or more layers of the reverse diffusion process 425 to ensure that the output image 430 includes content described by the text prompt 435 and/or other guidance prompt(s). For example, guidance features 445 can be combined with the noisy features using a cross-attention block within the reverse diffusion process 425.

According to some aspects, text encoder 440 comprises one or more artificial neural networks (ANNs). According to some aspects, text encoder 440 comprises a recurrent neural network (RNN). An RNN is a class of artificial neural network (ANN) in which connections between nodes form a directed graph along an ordered (i.e., a temporal) sequence, enabling the RNN to model temporally dynamic behavior such as predicting what element should come next in a sequence. Thus, an RNN is suitable for tasks that involve ordered sequences, such as text recognition (where words are ordered in a sentence). The term “RNN” may include finite impulse recurrent networks (characterized by nodes forming a directed acyclic graph), and infinite impulse recurrent networks (characterized by nodes forming a directed cyclic graph).

According to some aspects, text encoder 440 comprises a transformer. According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Cross-attention, also known as multi-head attention, is an extension of the attention mechanism. In some cases, cross-attention enables reverse diffusion process 425 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 425 to better understand the context and generate more accurate and contextually relevant outputs.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during image generation. Diffusion models may also be characterized by whether the noise is added to the image itself, or to image features generated by an encoder (i.e., latent diffusion). In a pixel diffusion model, noise is added and removed in pixel space. In a latent diffusion model, the noise is added (and removed) in a latent space of image features rather than in pixel space. Thus, a latent diffusion model generates image features using reverse diffusion, and these image features can be decoded to obtain a synthetic image.

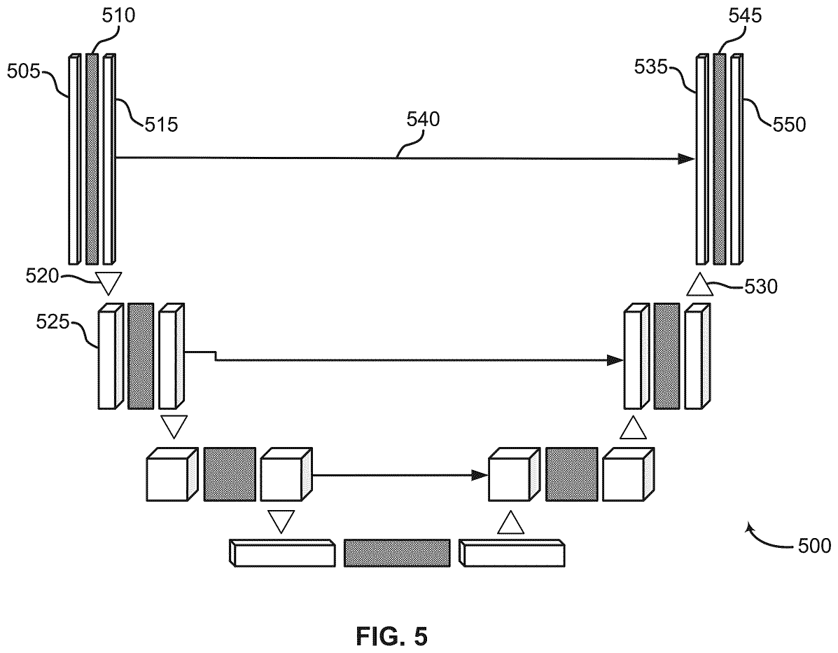

FIG. 5 shows an example of a U-Net according to aspects of the present disclosure. In some examples, U-Net 500 is an example of the component that performs the reverse diffusion process 425 of guided diffusion model 400 described with reference to FIG. 4 and includes architectural elements of the machine learning model 3020 described with reference to FIG. 30. The U-Net 500 depicted in FIG. 5 is an example of, or includes aspects of, the architecture used within the reverse diffusion process described with reference to FIG. 4.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that down-sampled features 525 features have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having a same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515.

### Media Processing

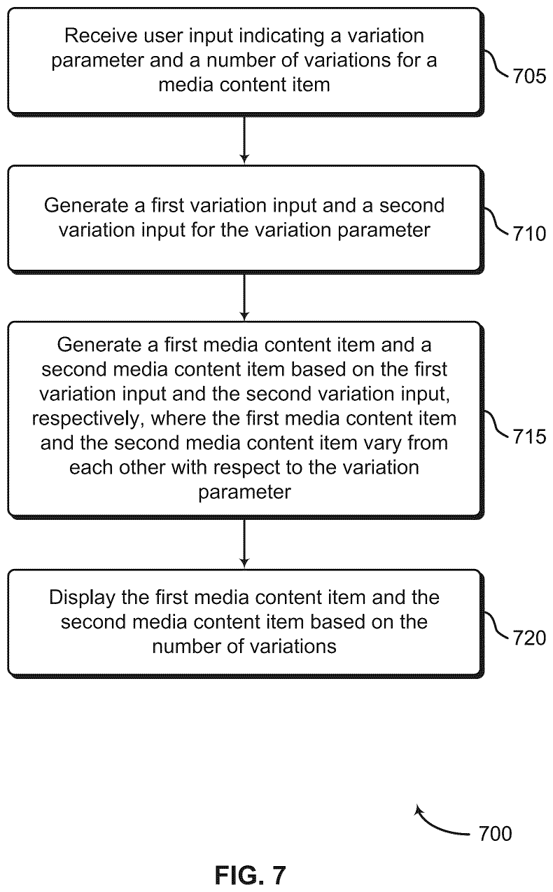

Methods for media processing are described with reference to FIGS. 6-26. FIG. 6 shows an example of a method 600 for displaying media content items according to aspects of the present disclosure. FIG. 7 shows an example of a method 700 for displaying generated media content items according to aspects of the present disclosure. Referring to FIGS. 6 and 7, according to some aspects, a computing apparatus (such as the computing apparatus described with reference to FIGS. 1 and 30) provides a user interface that accepts intuitive user inputs (such as contextual drop-down menu selections and drag-and-drop inputs) to adjust a media content item variation parameter that is used as an input for obtaining (by generating or retrieving) a set of media content items based on the variation parameter. A selected number of generated or retrieved media content items may be displayed in a grid. One or more of the media content items, corresponding variation parameters, or a combination thereof can be saved by the user for ease of reference and collaboration with other users.

A media content item may be dragged via user input to one or more tiles of the design board, allowing for the media content items to be arranged in a user-specified manner (for example, for storyboarding). A media content item and inputs associated with the media content item may be saved in memory, allowing the media content item to be redisplayed or re-retrieved/regenerated on demand, and the inputs to be reviewed and/or altered on demand. The computing apparatus can save a user's media content retrieval/generation settings for media content items presented on the design board, allowing the design board to retain a visual history of the user's journey through a design space.

A media content item and information corresponding to the media content item (such as input parameters, a machine learning model used to create the media content item, etc.) can be bookmarked to be saved as a favorite, allowing a user to keep track of favorite media content item variations inside of the design board. Accordingly, the user or a collaborating user with access to the design board can pick up where a previous design session left off.

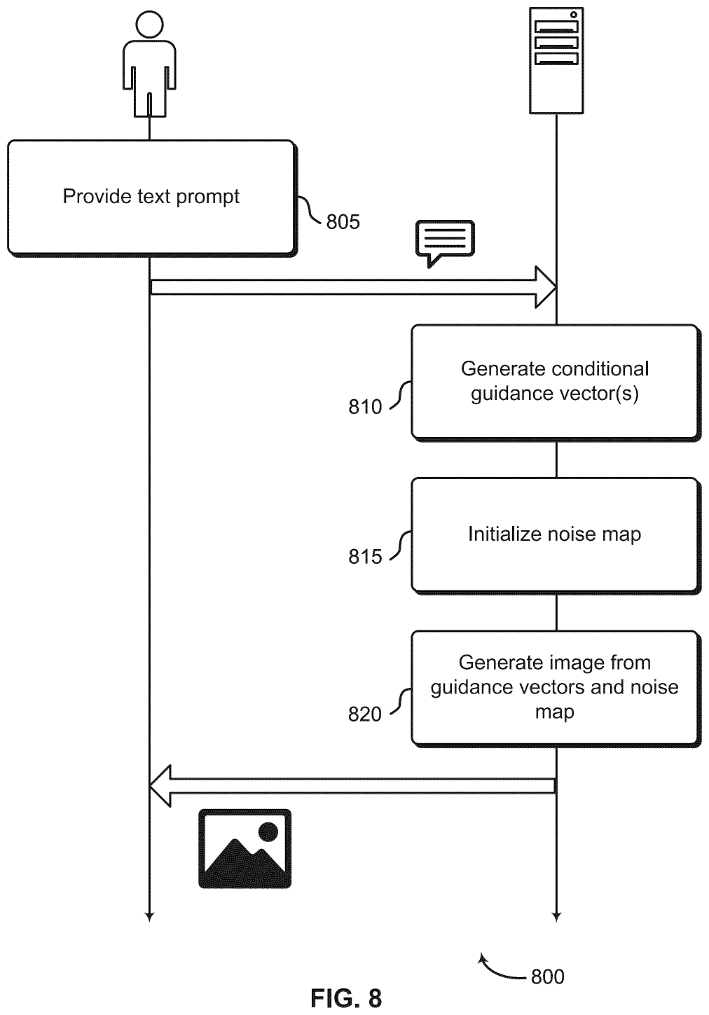

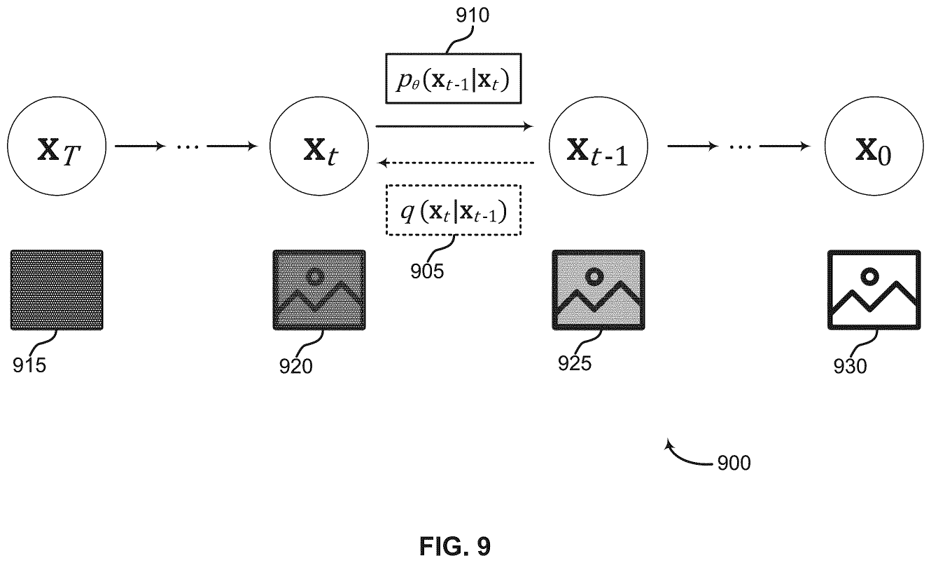

Examples of using a reverse diffusion process implemented by an image generation model of a machine learning model to generate a synthetic image are described with reference to FIGS. 8 and 9. Examples of obtaining and displaying one or more media content items are described with reference to FIGS. 10-26.

Referring to FIG. 6, at operation 605, the system receives user input indicating a variation parameter and a number of variations. In some cases, the operations of this step refer to, or may be performed by, a user interface as described with reference to FIG. 30.

In an example, the user interface is displayed on a user device (such as the user device described with reference to FIG. 1), and an element of the user interface receives the user input from a user such as the user described with reference to FIG. 1. In some embodiments, receiving the user input includes receiving a first input indicating the variation parameter and a second input indicating the number of variations. The first input and the second input may be received by different elements of the user interface.

In some embodiments, the user input includes a drag-and-drop input, where the number of variations is based on a length of the drag-and-drop input. The user interface may display a cord indicating the length of the drag-drop-input.

According to some aspects, the media content item (such as an image) is displayed on a design board (e.g., an infinite canvas that can be scrolled vertically or horizontally without boundaries). In some embodiments, the user provides the media content item to the user interface. In some embodiments, the system generates the media content item using a machine learning model (e.g., the machine learning model 3020 described with reference to FIG. 30) based on an input such as a text prompt.

At operation 610, the system identifies a first variation input and a second variation input corresponding to the variation parameter. In some cases, the operations of this step refer to, or may be performed by, a computing apparatus as described with reference to FIG. 30. For example, the computing apparatus identifies the first variation input and the second variation input as described with reference to FIGS. 10-26.

According to some aspects, identifying the first variation input and the second variation input includes identifying a first style variation and a second style variation based on the variation parameter and the number of variations. In some embodiments, the first style variation and the second style variation are selected from a predetermined set of style variations. According to some aspects, identifying the first variation input and the second variation input includes selecting a set of discrete values for the variation parameter from a continuous range based on the number of variations.

For example, if the variation parameter is color and the number of variations is two, identifying the first variation input and the second variation input could correspond to selecting the colors red and blue. Alternatively, if the number of variations is three, the colors red, blue and yellow could be identified. In some cases, a range of colors (e.g., based on RGB color value ranges) could determine how the variation inputs are selected or identified.

According to some aspects, identifying the first variation input and the second variation input comprises selecting a first random seed and a second random seed. In some embodiments, the variation parameter includes a temporal parameter, and the first media content item and the second media content item correspond to a temporal progression.

At operation 615, the system obtains a first media content item and a second media content item based on the first variation input and the second variation input, respectively, where the first media content item and the second media content item vary from each other with respect to the variation parameter. In some cases, the operations of this step refer to, or may be performed by, a media content component as described with reference to FIG. 30. For example, the media content component obtains the first media content item and the second media content item as described with reference to FIGS. 10-26.

In the example where the first variation input corresponds to the color red and the second variation input corresponds to the color blue, the first media content item could be an image of a red object or background and the second media content item could be an image with a blue object or background.

According to some aspects, obtaining the first media content item and the second media content item includes generating a first text prompt and a second text prompt corresponding to the first variation input and the second variation input, respectively, and generating, using a generative machine learning model (e.g., the machine learning model 3020 described with reference to FIG. 30) the first media content item and the second media content item based on the first text prompt and the second text prompt, respectively.

According to some aspects, the media content component generates a first search query and a second search query and retrieves the first media content item and the second media content item from a database, such as the database 125 described with reference to FIG. 1, based on the first search query and the second search query, respectively. In some embodiments, the first search query and the second search query are generated based on the first variation input and the second variation input, respectively.

According to some aspects, the media content component generates the first media content item and the second media content item by algorithmically modifying an original media content item based on the variation parameter.

At operation 620, the system displays the first media content item and the second media content item in a grid including a grid size (e.g., including a number of rows or a number of columns, and/or a number of grid indices) based on the number of variations. In some cases, the operations of this step refer to, or may be performed by, a user interface as described with reference to FIG. 30. For example, the user interface displays the first media content item and the second media content item as described with reference to FIGS. 10-26. According to some aspects, the first media content item and the second media content item are displayed on the design board. According to some aspects, the user interface receives an additional user input identifying one of the first media content item or the second media content item as a favorite and stores a favorite attribute for the identified one of the first media content item or the second media content item.

According to some aspects, the user interface obtains a text prompt. A first dimension of the grid corresponds to different media content items of the set of media content items and a second dimension of the grid corresponds to differences of the variation parameter. In some embodiments, the user interface receives an additional user input indicating an additional variation parameter, where rows of the grid correspond to differences of the variation parameter and columns of the grid correspond to differences of the additional variation parameter.

Referring to FIG. 7, at operation 705, the system receives user input indicating a variation parameter and a number of variations. In some cases, the operations of this step refer to, or may be performed by, a user interface as described with reference to FIG. 30. For example, the user interface receives the user input as described with reference to FIGS. 6 and 10-26.

At operation 710, the system identifies a first variation input and a second variation input for the variation parameter. In some cases, the operations of this step refer to, or may be performed by, a computing apparatus as described with reference to FIGS. 1 and 30. For example, the user interface generates the set of variation inputs as described with reference to FIGS. 6 and 10-26.

At operation 715, the system generates a first media content item and a second media content item based on the first variation input and the second variation input, respectively, where the first media content item and the second media content item vary from each other with respect to the variation parameter. In some cases, the operations of this step refer to, or may be performed by, a machine learning model as described with reference to FIG. 30 or an image generation model included in the machine learning model. For example, the machine learning model generates the set of media content items as described with reference to FIGS. 6 and 8-26, using media content item and the set of variation inputs as inputs for one or more generative processes.

At operation 720, the system displays the first media content item and the second media content item based on the number of variations. In some cases, the operations of this step refer to, or may be performed by, a user interface as described with reference to FIG. 30. For example, the user interface displays the set of media content items as described with reference to FIGS. 6 and 10-26.

FIG. 8 shows an example of a method 800 for conditional image generation according to aspects of the present disclosure. In some examples, method 800 describes an operation of the image generation model of the machine learning model 3020 described with reference to FIG. 30, such as an application of the guided diffusion model 400 described with reference to FIG. 4. In some examples, these operations are performed by a system including a processor executing a set of codes to control functional elements of an apparatus such as the image generation model described in FIG. 4.

Additionally or alternatively, steps of the method 800 may be performed using special-purpose hardware. Generally, these operations are performed according to the methods and processes described in accordance with aspects of the present disclosure. In some cases, the operations described herein are composed of various substeps, or are performed in conjunction with other operations.

At operation 805, a user provides an input (such as a text prompt) describing content to be included in a generated image. For example, a user may provide the prompt “a person playing with a cat”. In some examples, the set of variation inputs is provided as guidance. In some examples, guidance can be provided in a form other than text, such as via an image, a sketch, a layout, etc.

At operation 810, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 815, a noise map is initialized that includes random noise. The noise map may be in a pixel space or a latent space. By initializing an image with random noise, different variations of an image including the content described by the conditional guidance can be generated.

At operation 820, the system generates an image based on the noise map and the conditional guidance vector. For example, the image may be generated using a reverse diffusion process as described with reference to FIG. 9.

FIG. 9 shows a diffusion process 900 according to aspects of the present disclosure. In some examples, diffusion process 900 describes an operation of the image generation model of the machine learning model 3020 described with reference to FIG. 30, such as the reverse diffusion process 425 of guided diffusion model 400 described with reference to FIG. 4.

As described above with reference to FIG. 4, using a diffusion model can involve both a forward diffusion process 905 for adding noise to an image (or features in a latent space) and a reverse diffusion process 910 for denoising the images (or features) to obtain a denoised image. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate images with successively greater noise, and a neural network is trained to perform the reverse diffusion process 910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 910, the model begins with noisy data x_{T}, such as a noisy image 415 and denoises the data to obtain the p(xₜ₋₁|xₜ). At each step t−1, the reverse diffusion process 910 takes xₜ, such as first intermediate image 920, and t as input. Here, t represents a step in the sequence of transitions associated with different noise levels, The reverse diffusion process 910 outputs xₜ₋₁, such as second intermediate image 925 iteratively until x_{T} reverts back to x₀, the original image p30. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T};0, I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and i represents the generated image with high image quality.

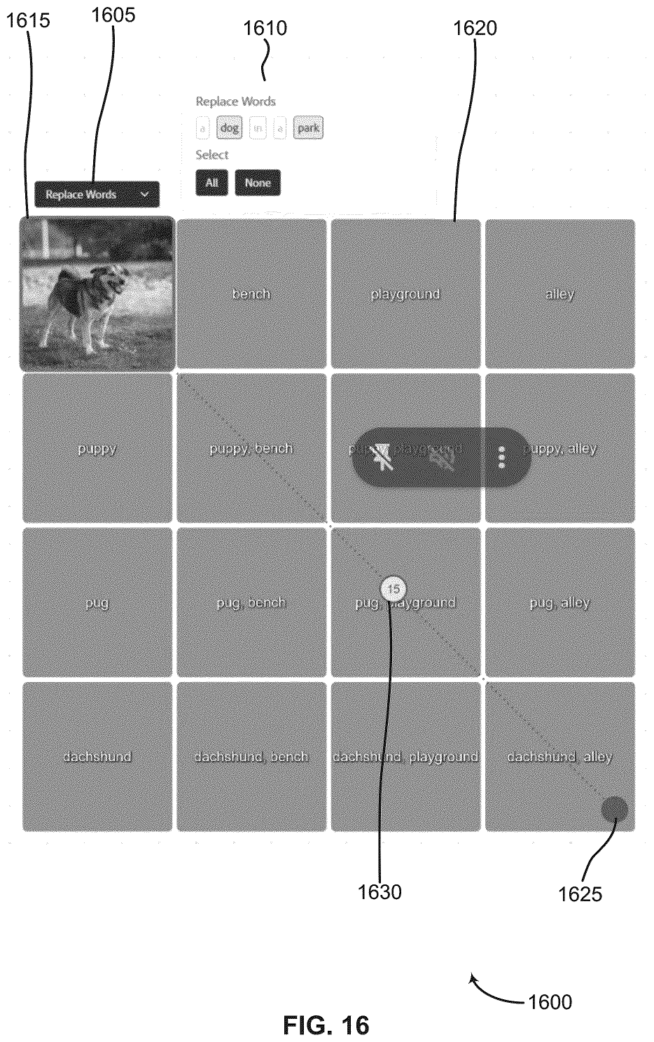

FIGS. 10-15 show an example of generating additional media content items using a variation handle according to aspects of the present disclosure. FIG. 16 shows an example of replacing words in a text prompt using a variation handle according to aspects of the present disclosure.

Referring to FIGS. 10-16, according to some aspects, a variation handle interface is displayed. In an example, a user clicks and drags a variation handle, and a set of tiles appear in an area defined by a rectangle created by a center of a selected tile and a location of the dragged variation handle. The tiles display information relevant to a current variation mode (such as a seed variation mode, a word replacement mode, a style mode, etc.). For example, each of the tiles may display a seed number, replaced word, style, etc. that will be used as input for creating a corresponding media content item.

Once the user has created a grid of tiles, the user releases the variation handle to instruct the computing apparatus to generate variation inputs according to the variation mode and the selected variation parameters, and to generate and display a set of media content items based on the set of variation inputs. The variation handle may operate on single selections, multiple selections, or a combination thereof. In at least one embodiment, when used with multiple selections, the variation handle operates on a single axis (e.g., a horizontal axis or a vertical axis and applies same settings across corresponding rows or columns of the design board.

In at least one embodiment, the variation handle can be pulled to define a number of generations desired by a user. A number displayed on a cord of the variation handle may correspond to a technical parameter or to a generation method, such as a word replacement. The variation handle enables users to generate variations of media content items with speed and efficiency.

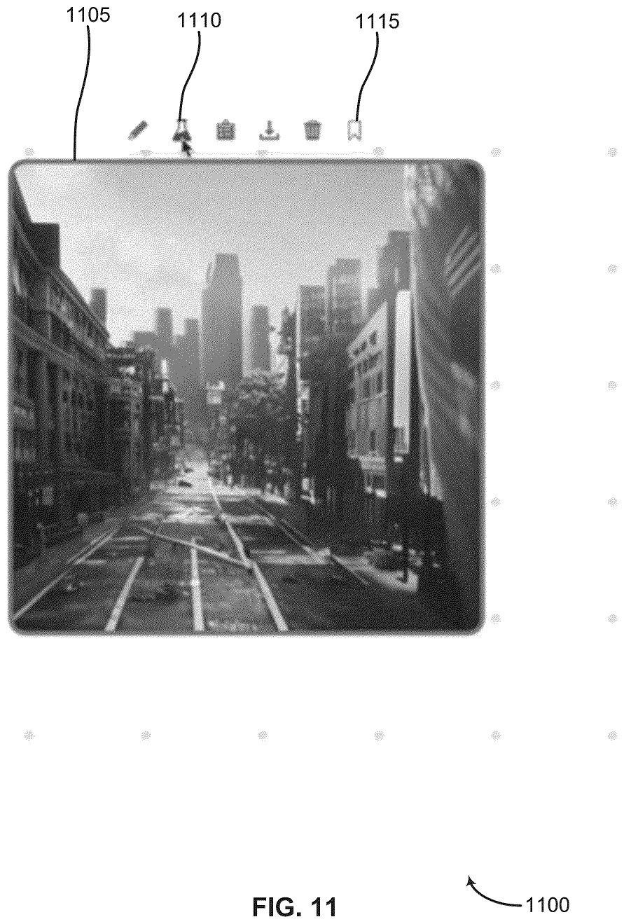

FIG. 10 shows design board 1000, image 1005, text prompt interface 1010, style image preview 1015, seed selection interface 1020, and iterations interface 1025. Design board 1000 is an example of, or includes aspects of, the corresponding element described with reference to FIGS. 11-26. Image 1005 is an example of, or includes aspects of, the corresponding element described with reference to FIGS. 11-14.

In the example of FIG. 10, image 1005 is displayed on a tile of design board 1000. Text prompt interface 1010 shows a text prompt that was used to generate image 1005, style image preview 1015 shows a space for displaying a style image input for generating image 1005 (as shown, not used), seed selection interface 1020 shows a seed number (126) used for generating image 1005 and an interface for changing the seed to regenerate image 1005, and iterations interface 1025 shows a number of image generation process iterations (40) used for generating image 1005 and an interface for changing the number of image generation process iterations.

FIG. 11 shows design board 1100, image 1105, parameter variation tool 1110, and bookmark 1115. Design board 1100 is an example of, or includes aspects of, the corresponding element described with reference to FIGS. 10 and 12-26. Image 1105 is an example of, or includes aspects of, the corresponding element described with reference to FIGS. 10 and 12-14.

In the example of FIG. 11, image 1105 (e.g., image 1005) is shown on design board 1100 (e.g., design board 1000) adjacent to a selection interface including parameter variation tool 1110 and bookmark 1115, where the selection interface is displayed in response to interacting with (for example, by clicking on or hovering over) image 1105. In some cases, a user input to parameter variation tool 1110 allows the user to select a parameter variation mode. In some cases, a user input to bookmark 1115 allows corresponding image 1105 to be saved as a favorite (for example, in a database, such as the database described with reference to FIG. 1).

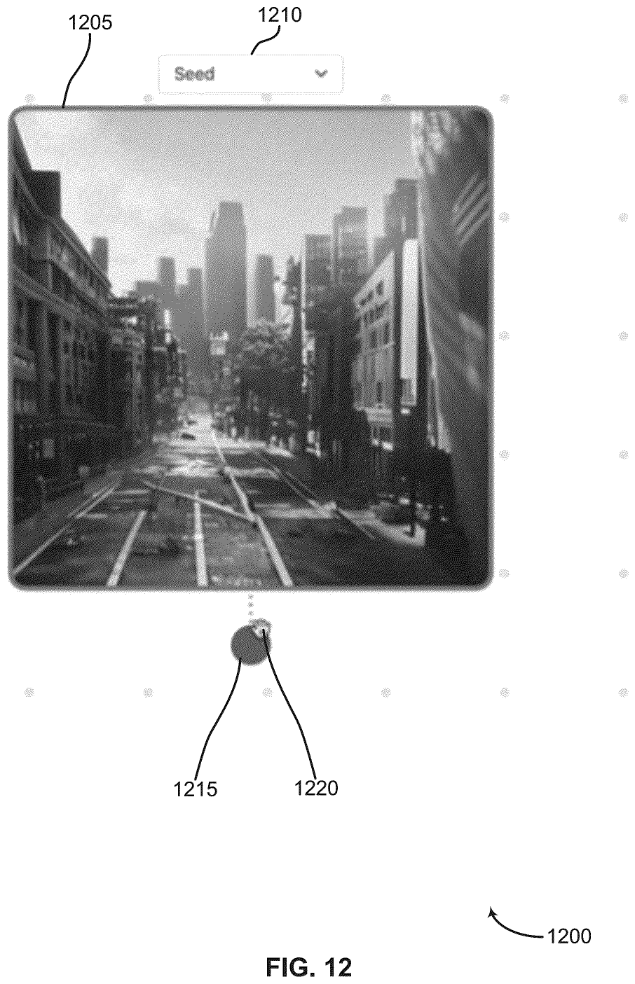

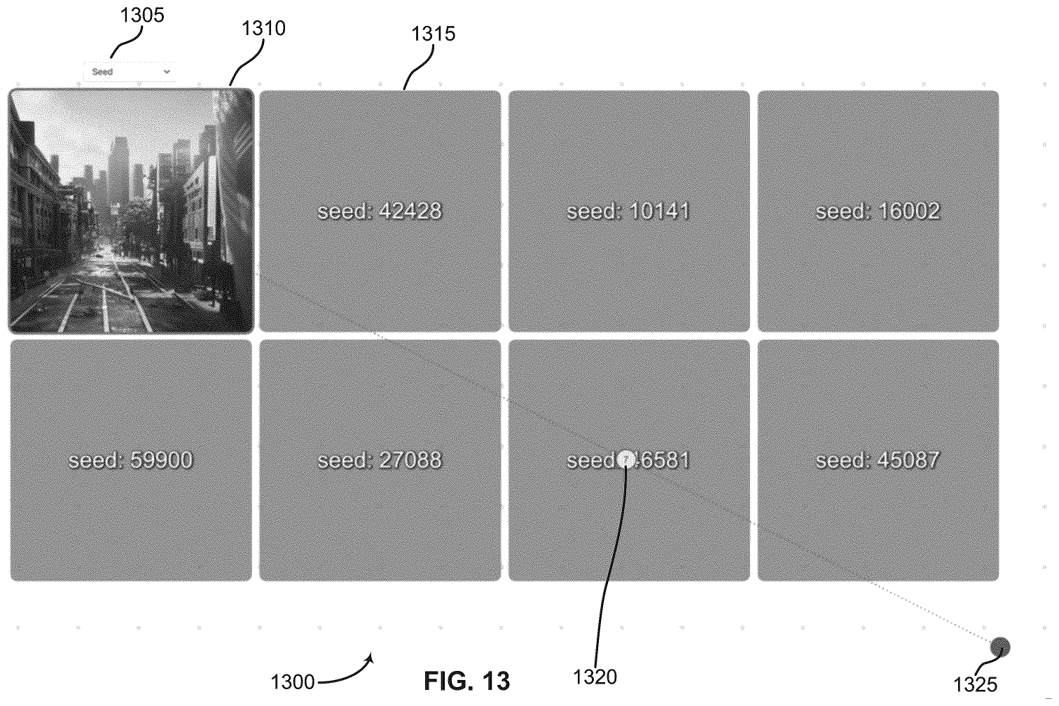

FIG. 12 shows design board 1200, image 1205, parameter selection drop-down menu 1210, variation handle 1215, and cursor 1220. Design board 1200 is an example of, or includes aspects of, the corresponding element described with reference to FIGS. 10, 11, and 13-26. Image 1205 is an example of, or includes aspects of, the corresponding element described with reference to FIGS. 10, 11, 13, and 14. Parameter selection drop-down menu 1210 is an example of, or includes aspects of, the corresponding element described with reference to FIGS. 13, 16, 17, 20, 21, and 23. Variation handle 1215 is an example of, or includes aspects of, the corresponding element described with reference to FIGS. 13 and 16.

In the example of FIG. 12, image 1205 (e.g., image 1105) is shown on design board 1200 (e.g., design board 1100) adjacent to parameter selection drop-down menu 1210 (displayed in response to an input based on an input to parameter variation tool 1110). Parameter selection drop-down menu 1210 shows “Seed” as an active variation parameter for variation handle 1215. Cursor 1220 shows an open hand, indicating that variation handle 1215 can be grabbed and dragged by a user.

FIG. 13 shows design board 1300, parameter selection drop-down menu 1305, image 1310, additional tile 1315, additional tile count 1320, and variation handle 1325. Design board 1300 is an example of, or includes aspects of, the corresponding element described with reference to FIGS. 10-12 and 14-25. Parameter selection drop-down menu 1305 is an example of, or includes aspects of, the corresponding element described with reference to FIGS. 12, 16, 17, 20, 21, and 23. Image 1310 is an example of, or includes aspects of, the corresponding element described with reference to FIGS. 10-12, and 14. Additional tile count 1320 is an example of, or includes aspects of, the corresponding element described with reference to FIG. 16. Variation handle 1325 is an example of, or includes aspects of, the corresponding element described with reference to FIGS. 12 and 16.

In the example of FIG. 13, a user has dragged variation handle 1325 to a new position on design board 1300 (e.g., design board 1200). Additional tile count 1320 (7) is shown on a cord of variation handle 1325, indicating a number of additional tiles (including additional tile 1315) of design board 1300 that will be populated with additional images generated based on the image generation parameters for image 1310 (e.g., image 1205) with corresponding modified seeds. As shown in FIG. 13, each additional tile includes text identifying a randomly chosen seed (for example, via random number generation) that each corresponding additional image will be generated based on. In some cases, a seed is an input to a diffusion model that determines an appearance of a generated image, such that two images generated by a same diffusion model with a same number of iterations based on a same seed will be identical.

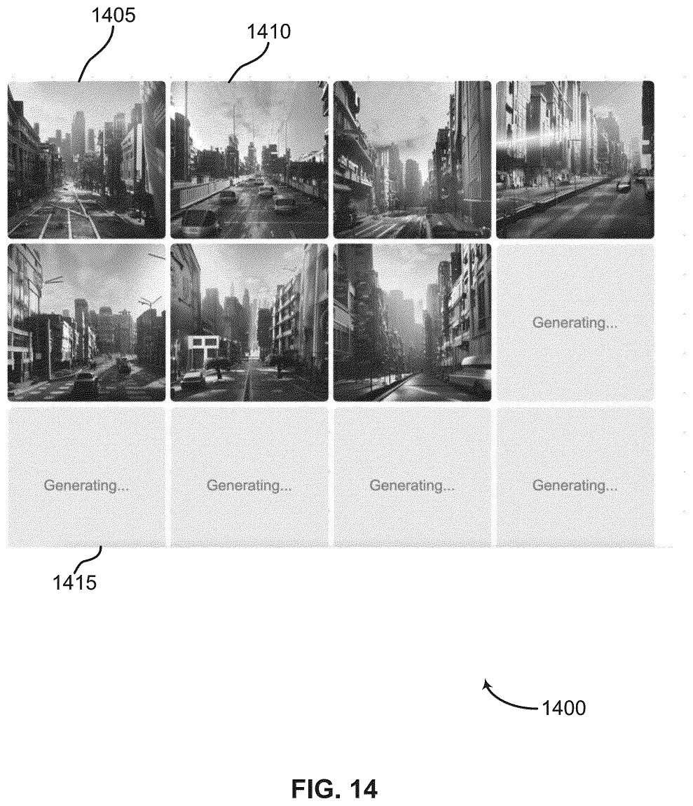

FIG. 14 shows design board 1400, image 1405, additional image 1410, and second additional tile 1415. Design board 1400 is an example of, or includes aspects of, the corresponding element described with reference to FIGS. 10-13 and 15-26. Image 1405 is an example of, or includes aspects of, the corresponding element described with reference to FIGS. 10-13.

In the example of FIG. 14, design board 1400 (e.g., design board 1300) displays additional images (including additional image 1410) generated based on image 1405 and the seeds of FIG. 13, where some additional tiles (including additional tile 1414) display text (e.g., “Generating . . . ”) indicating that an image generation process is in progress.

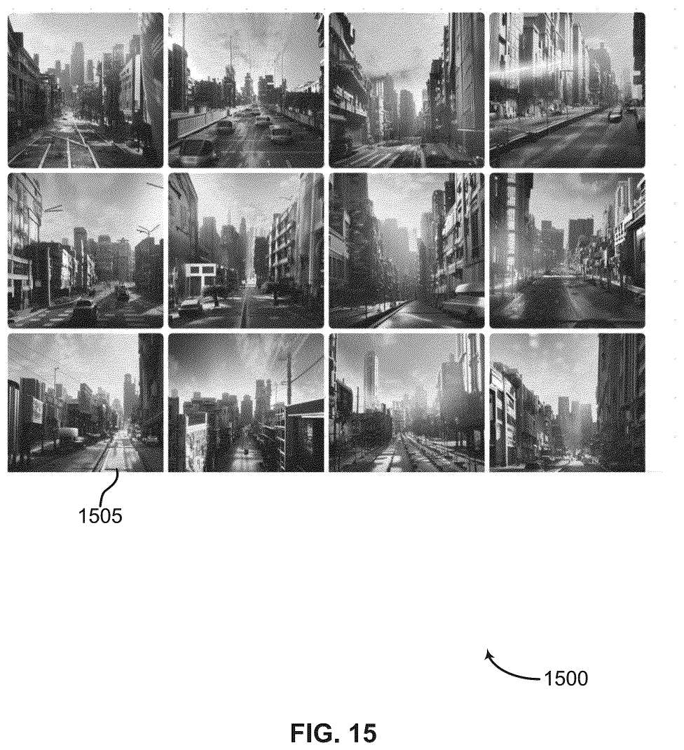

FIG. 15 shows design board 1500 and second additional image 1505. Design board 1500 is an example of, or includes aspects of, the corresponding element described with reference to FIGS. 10-14 and 16-26. In the example of FIG. 15, design board 1500 (e.g., design board 1400) displays a complete set of additional images (including second additional image 1505) generated based on the image and seeds of FIG. 14.

FIG. 16 shows design board 1600, parameter selection drop-down menu 1605, word replacement interface 1610, second image 1615, additional tile 1620, variation handle 1625, and additional tile count 1630. Design board 1600 is an example of, or includes aspects of, the corresponding element described with reference to FIGS. 10-15 and 17-26. Parameter selection drop-down menu 1605 is an example of, or includes aspects of, the corresponding element described with reference to FIGS. 12, 13, 17, 20, 21, and 23. Variation handle 1625 is an example of, or includes aspects of, the corresponding element described with reference to FIGS. 12 and 13. Additional tile count 1630 is an example of, or includes aspects of, the corresponding element described with reference to FIG. 13.

In the example of FIG. 16, a user has selected second image 1615 and “Replace Words” in corresponding parameter selection drop-down menu 1605. In response, design board 1600 displays word replacement interface 1610, which displays each word of a text prompt (provided in any language, including English) corresponding to the generation of second image 1615 as a selectable element. The user has selected the words “dog” and “park” in the text prompt “a dog in a park” to be replaced. The user has dragged variation handle 1625 to a position on design board 1600 such that 15 additional tiles (indicated by additional tile count 1630) have been selected.

In the example of FIG. 16, when variation handle 1625 is dragged across an additional tile, the additional tile is populated with one or more randomly identified replacement words for the one or more words selected in word replacement interface 1610. In some cases, the one or more replacement words are provided by a word replacement algorithm (such as the generative algorithm described with reference to FIG. 30). In some cases, the one or more replacement words are provided by a language generation model included in a machine learning model (such as the machine learning model described with reference to FIG. 30).

In the example of FIG. 16, in response to a user releasing variation handle 1625, an image generation model included in the machine learning model generates an image for each selected additional tile based on the variation input (e.g., the modified text prompt including the corresponding replacement words for the selected additional tile).

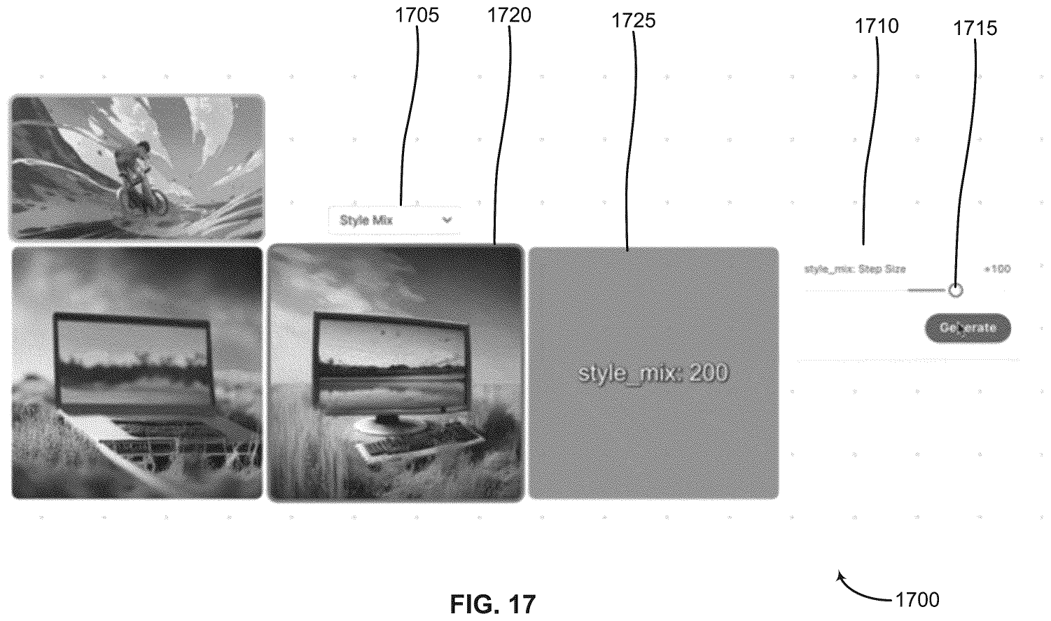

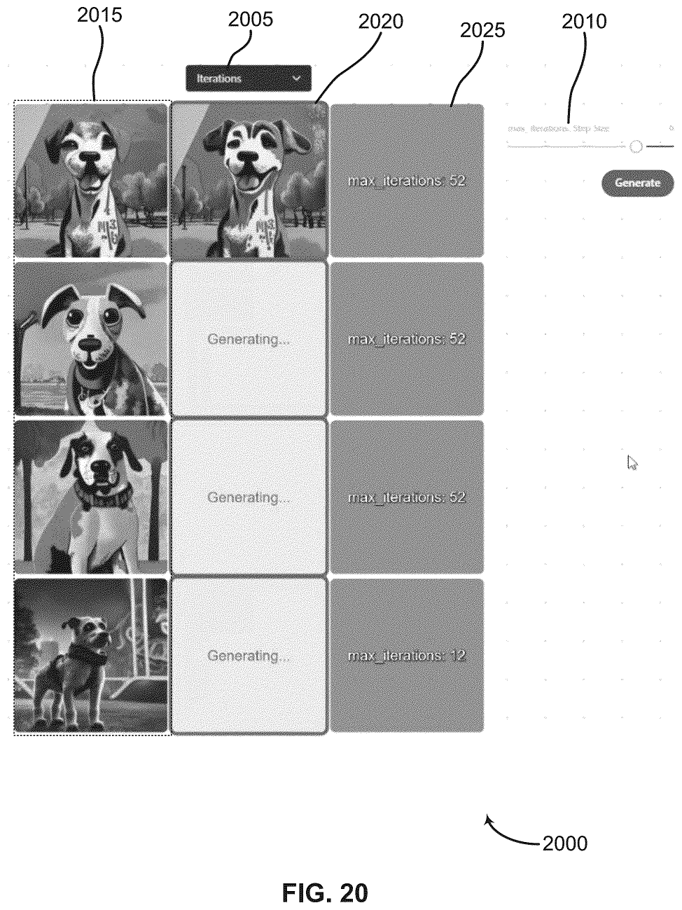

FIGS. 17-19 show an example of generating additional media content items using a parameter stepper tool according to aspects of the present disclosure. FIG. 20 shows an example of varying image generation iterations using a parameter stepper tool according to aspects of the present disclosure.

Referring to FIGS. 17-20, aspects of the present disclosure allow a user to “step” along a numerical range of values for a variation parameter, giving the user control over some of the more technical parameters involved in media content item generation or retrieval. The tool allows users to visually explore the effect of these parameters without requiring deep technical knowledge of what the parameters do.

For example, according to some aspects, a parameter stepper interface is displayed. The parameter stepper interface is applied to parameters having associated numerical values (such as seeds, generation iteration counts, color values, etc.) that can be incremented or stepped. When the user selects a media content item and the applicable variation mode, the parameter stepper interface may appear adjacent to the selected media content item. In some embodiments, the parameter stepper interface includes a slider that allows the numerical value to be adjusted. A selection of the numerical values of the parameter stepper interface instruct the computing apparatus to generate corresponding variation inputs.

In response to generating and displaying a media content item based on the variation inputs generated based on the parameter stepper interface, a viewport of the design board may move to a center of the generated media content item. In some cases, the user can continue to step along the range of parameter values.

FIG. 17 shows an example of generating additional media content items using a parameter stepper tool according to aspects of the present disclosure. The example shown includes design board 1700, parameter selection drop-down menu 1705, parameter stepper interface 1710, parameter stepper slider 1715, third image 1720, and additional tile 1725.

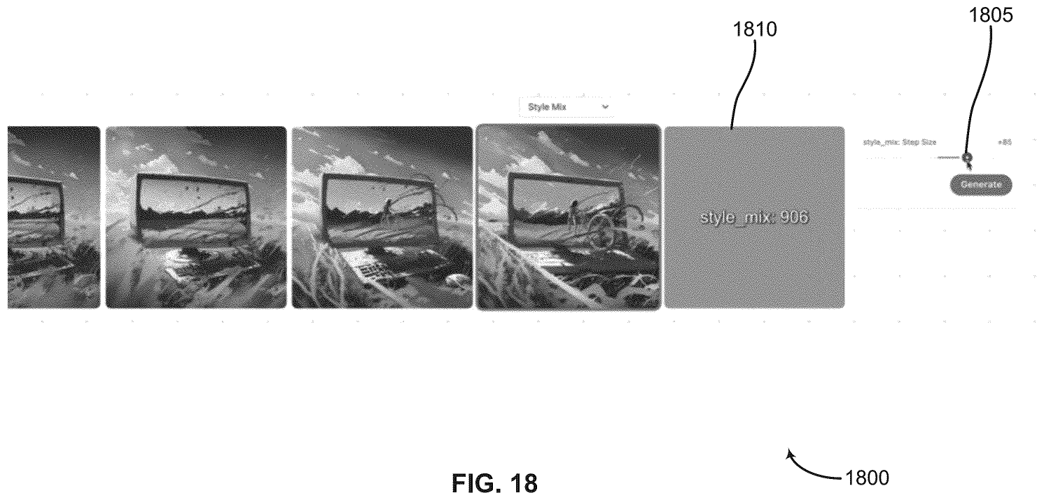

Design board 1700 is an example of, or includes aspects of, the corresponding element described with reference to FIGS. 10-16, and 18-26. Parameter selection drop-down menu 1705 is an example of, or includes aspects of, the corresponding element described with reference to FIGS. 12, 13, 16, 20, 21, and 23. Parameter stepper interface 1710 is an example of, or includes aspects of, the corresponding element described with reference to FIG. 20. Parameter stepper slider 1715 is an example of, or includes aspects of, the corresponding element described with reference to FIG. 18.

In the example of FIG. 17, a user has selected “Style Mix” as a parameter to be incremented via parameter selection drop-down menu 1705 displayed on design board 1700. Parameter stepper interface 1710 including parameter stepper slider 1715 is displayed adjacent to additional tile 1725, where additional tile 1725 will display an image generated based on the incremented parameter and third image 1720. As shown in FIG. 17, additional tile 1725 includes a text preview of the value (200) that the additional image will be generated based on. In some cases, after the additional image is generated and displayed in the additional tile, a further additional tile will likewise display a text preview of a value (200) that a further additional image will be generated based on.

FIG. 18 shows an example of generating additional media content items using a parameter stepper tool according to aspects of the present disclosure. The example shown includes design board 1800, parameter stepper slider 1805, and second additional tile 1810. Design board 1800 is an example of, or includes aspects of, the corresponding element described with reference to FIGS. 10-17 and 19-26. Parameter stepper slider 1805 is an example of, or includes aspects of, the corresponding element described with reference to FIG. 17.

In the example of FIG. 18, second additional tile 1810 shows a changed value (906) for a style mix parameter from the example of FIG. 17 based on a user input to parameter stepper slider 1805.

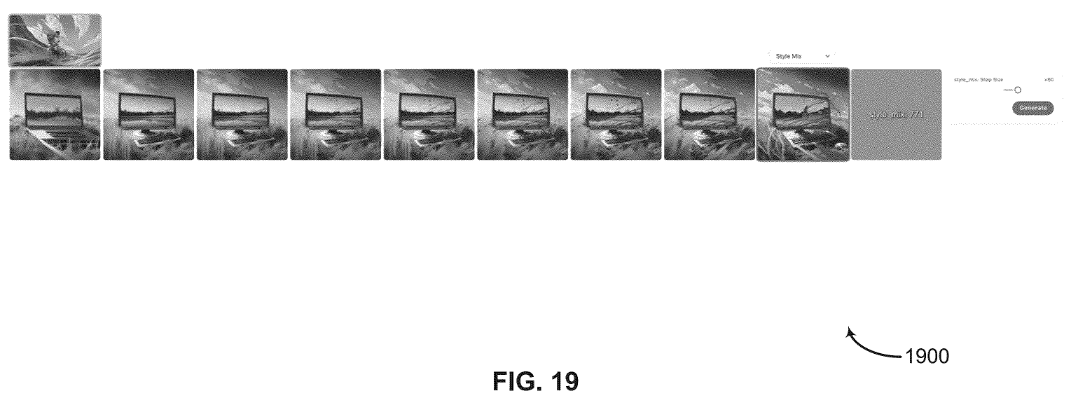

FIG. 19 shows an example of generating additional media content items using a parameter stepper tool according to aspects of the present disclosure. Design board 1900 is an example of, or includes aspects of, the corresponding element described with reference to FIGS. 10-18 and 20-26. In the example of FIG. 19, a row of images generated based on incremented values of a style mix parameter is displayed on design board 1900.

FIG. 20 shows an example of varying image generation iterations using a parameter stepper tool according to aspects of the present disclosure. The example shown includes design board 2000, parameter selection drop-down menu 2005, parameter stepper interface 2010, set of images 2015, additional fourth image 2020, and additional tile 2025.

Design board 2000 is an example of, or includes aspects of, the corresponding element described with reference to FIGS. 10-19 and 21-26. Parameter selection drop-down menu 2005 is an example of, or includes aspects of, the corresponding element described with reference to FIGS. 12, 13, 16, 17, 21, and 23. Parameter stepper interface 2010 is an example of, or includes aspects of, the corresponding element described with reference to FIG. 17.

In the example of FIG. 20, a user has selected “Iterations” (referring to a number of iterations to be used in an iterative image generation process) as a variation parameter to be incremented in parameter selection drop-down menu 2005 and has selected each image in set of images 2015 (displayed in a column on design board 2000). By selecting multiple images, the user can simultaneously generate additional images based on incremented iteration values for each of set of images 2015.

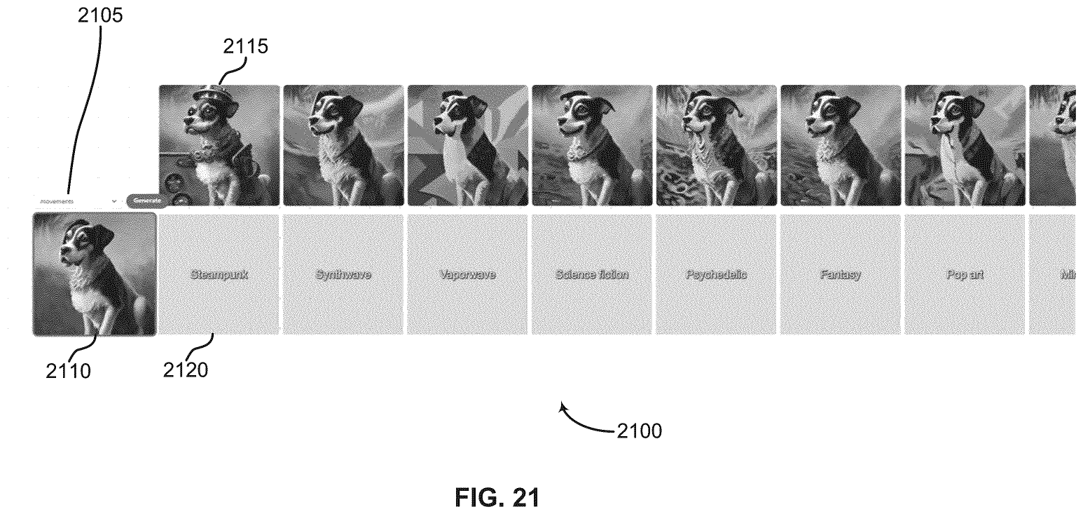

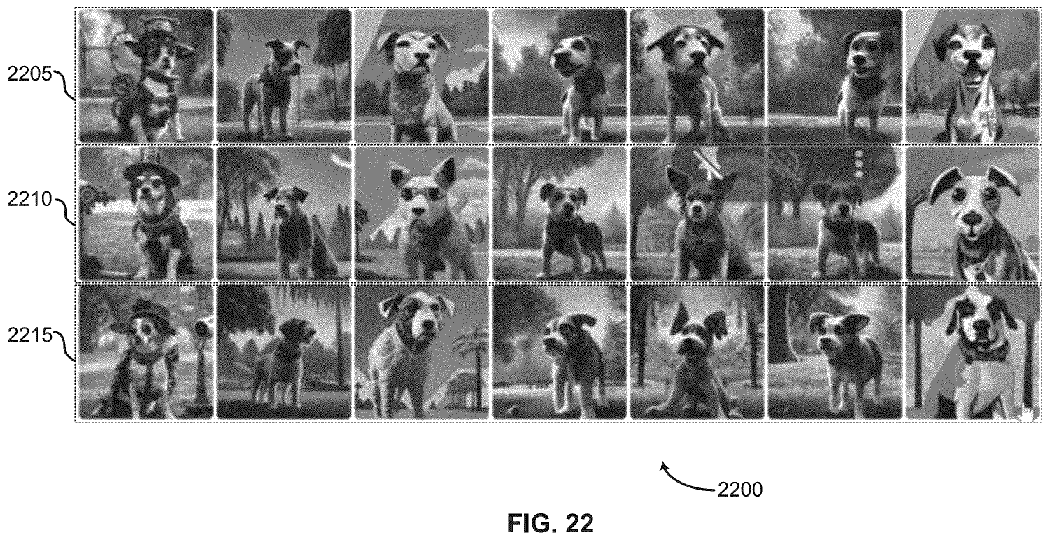

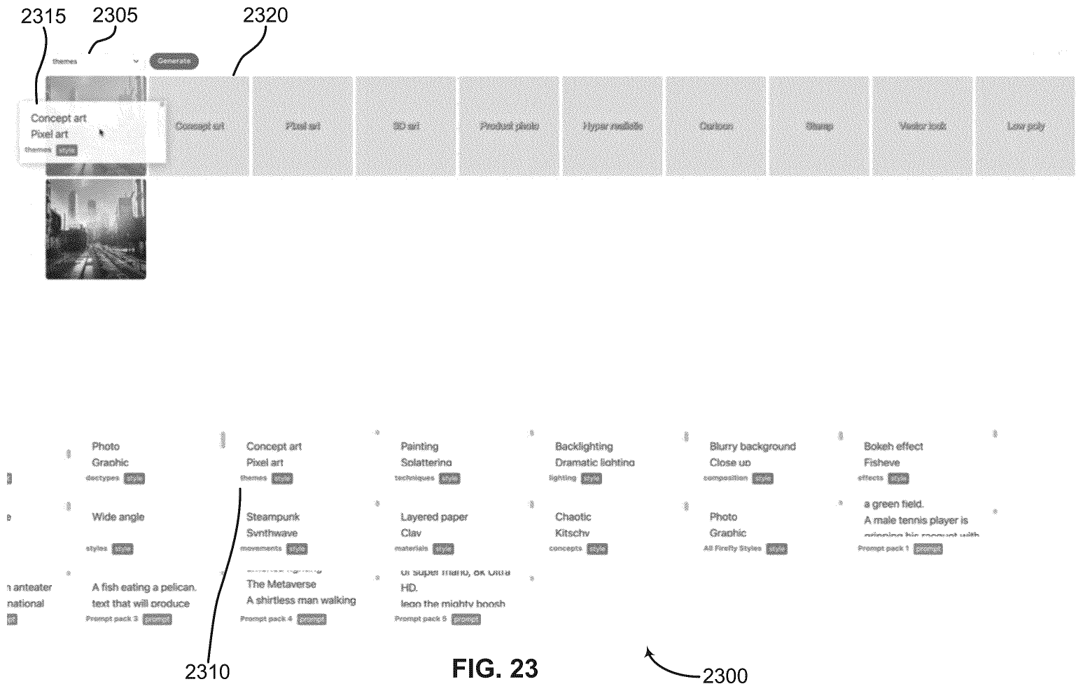

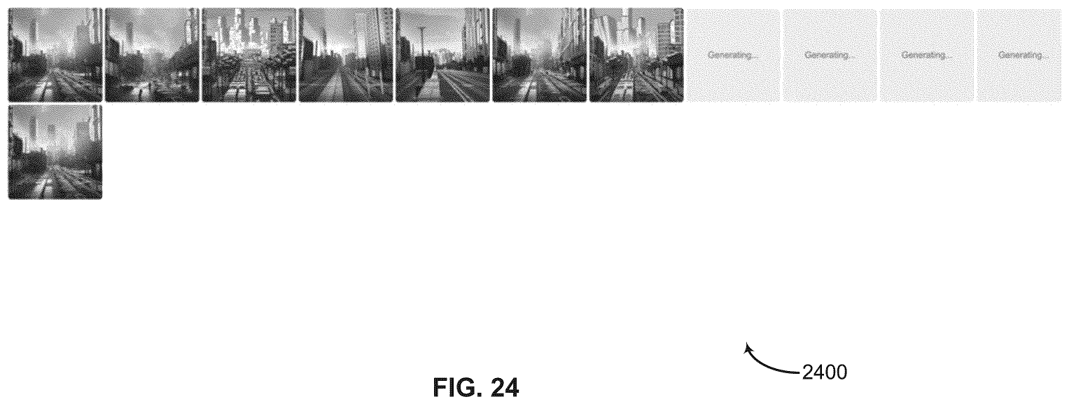

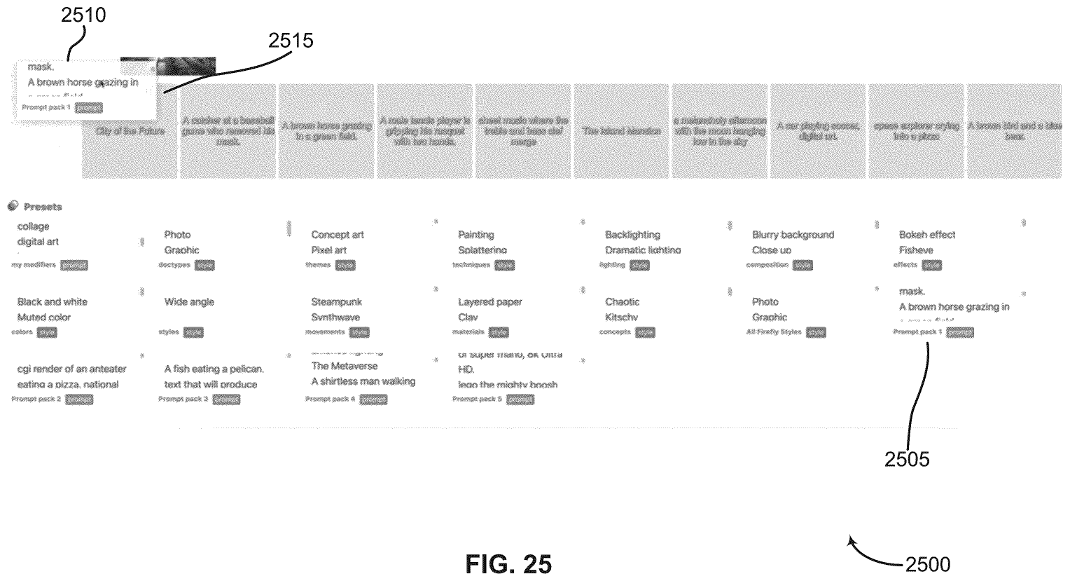

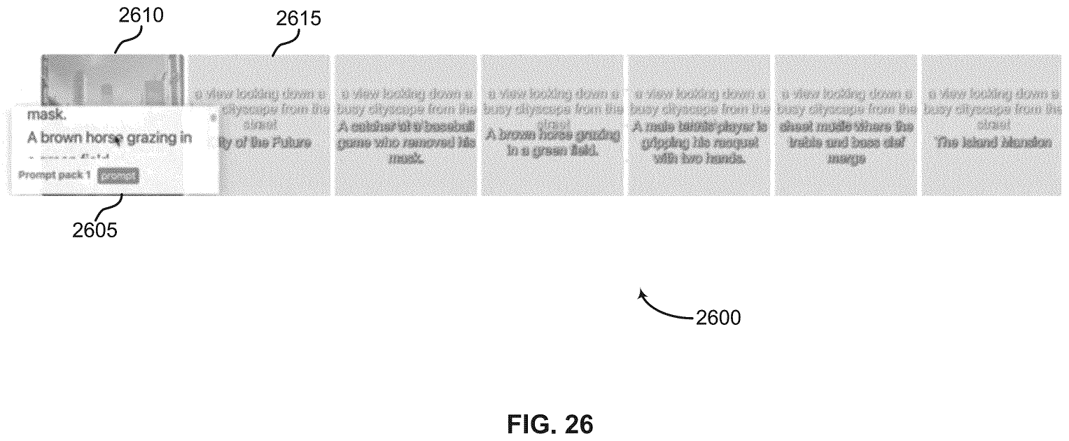

FIGS. 21-22 show an example of generating additional media content items using modifier presets according to aspects of the present disclosure. FIGS. 23-24 show an example of creating additional media content items based on a media content item using modifier presets according to aspects of the present disclosure. FIG. 25 shows an example of creating a set of media content items using a set of text prompt presets according to aspects of the present disclosure. FIG. 26 shows an example of creating a set of additional content media items by applying a set of text prompt presets to a content media item according to aspects of the present disclosure.

Referring to FIGS. 21-26, according to some aspects, a set of media content items can be retrieved and/or generated based on a set of pre-defined or user-defined modifiers. These modifiers can be used to set a style, perform a permutation operation, or be programmed to perform more advanced transformations (e.g., apply a reference image as a ControlNet input to a group of tiles at once, etc.), provide text prompts, etc. In some embodiments, a set of predefined modifiers is randomly generated. For example, where the set of pre-defined modifiers includes a set of text prompts, the text prompts can be user selected or defined, randomly selected from a set of text prompts stored in a database, or can be randomly generated themselves. In some cases, each generation resulting from a modifier list appears on the canvas as a new tile.

A ControlNet is a neural network structure to control image generation models by adding extra conditions. In some embodiments, a ControlNet architecture copies the weights from some of the neural network blocks of the image generation model to create a “locked” copy and a “trainable” copy. The “trainable” one learns your condition. The “locked” copy preserve the parameters of the original model. The trainable copy can be tuned with a small dataset of image pairs, while preserving the locked copy ensures that original model is preserved. For example, a ControlNet architecture can be used to control a diffusion U-Net (i.e., to add controllable parameters or inputs that influence the output). Encoder layers of the U-Net can be copied and tuned. Then zero convolution layers can be added. The output of the control network can be input to decoder layers of the U-Net.

According to some aspects, a modifier list can be dragged onto a tile from a window on the bottom of the screen, or selected from a dropdown item when a tile is selected. When applied to a tile, additional tiles may be displayed adjacent to the tile, with text describing a modification to be made displayed on each additional tile. When the user provides an input to a “generate” element of the user interface, media content items are displayed in corresponding additional tiles according to rules of the modifier list. In some embodiments, the modifier list is used to quickly apply multiple styles to a selected tile or media content item.

According to some aspects, each operation with a different variation control generates a new media content item in a new tile, and so a non-linear, non-destructive editing interface is provided. Accordingly, a quality and efficiency of a user experience of creating media content items is increased.

FIG. 21 shows an example of generating additional media content items using modifier presets according to aspects of the present disclosure. The example shown includes design board 2100, parameter selection drop-down menu 2105, fourth image 2110, additional fourth image 2115, and additional tile 2120.

Design board 2100 is an example of, or includes aspects of, the corresponding element described with reference to FIGS. 10-20 and 22-26. Parameter selection drop-down menu 2105 is an example of, or includes aspects of, the corresponding element described with reference to FIGS. 12, 13, 16, 17, 20, and 23.

In the example of FIG. 21, parameter selection drop-down menu 2105, fourth image 2110, additional fourth image 2115, and additional tile 2120 are displayed on design board 2100. “Movements” (e.g., a style selection) has been selected in parameter selection drop-down menu 2105, and images (including additional fourth image 2115) have been generated based on fourth image 2110 (e.g., an original content item) using styles described by text included in corresponding adjacent additional tiles (including additional tile 2120). In the example of FIG. 21, the row of tiles of design board 2100 including the tile for additional fourth image 2115 includes images generated based on fourth image 2110 and a common input parameter (such as a common seed), while the row of tiles including additional tile 2120 will include images generated based on fourth image 2110 and a different common input parameter (such as a different seed).

In some cases, a “style” includes one or more words that are provided to the machine learning model by being appended to a text prompt, or as an additional guidance prompt.

FIG. 22 shows an example of generating additional media content items using modifier presets according to aspects of the present disclosure. The example shown includes design board 2200, first set of additional fourth images 2205, second set of additional fourth images 2210, and third set of additional fourth images 2215. Design board 2200 is an example of, or includes aspects of, the corresponding element described with reference to FIGS. 10-21 and 23-26.

In the example of FIG. 22, design board 2200 (e.g., design board 2100) shows three rows of images generated based on styles described by FIG. 21, where each of first set of additional fourth images 2205, second set of additional fourth images 2210, and third set of additional fourth images 2215 are generated based on a common input parameter, and vertically aligned images are generated based on a common style.

FIG. 23 shows an example of creating additional media content items based on a media content item using modifier presets according to aspects of the present disclosure. The example shown includes design board 2300, parameter selection drop-down menu 2305, style presets representation 2310, dragged style presets representation 2315, and additional tile 2320.

Design board 2300 is an example of, or includes aspects of, the corresponding element described with reference to FIGS. 10-22 and 24-26. Parameter selection drop-down menu 2305 is an example of, or includes aspects of, the corresponding element described with reference to FIGS. 12, 13, 16, 17, 20, and 21.

In the example of FIG. 23, a set of styles included in style presets representation 2310 (including “Concept art”, “Pixel art”, “3D art”, “Product photo”, “Hyper realistic”, “Cartoon”, “Stamp”, “Vector look”, and “Low poly”) are applied to an image by dragging style presets representation 2310 onto the image. In response, a set of additional tiles (including additional tile 2320) are each populated with a style from the style presets, and each of the additional tiles will display an additional image generated based on the image and the corresponding style.

FIG. 24 shows an example of creating additional media content items based on a media content item using modifier presets according to aspects of the present disclosure. Design board 2400 is an example of, or includes aspects of, the corresponding element described with reference to FIGS. 10-23 and 25-26. FIG. 24 shows a set of images generated based on the styles described with reference to FIG. 23.

FIG. 25 shows an example of creating a set of media content items using a set of text prompt presets according to aspects of the present disclosure. The example shown includes design board 2500, text prompt preset representation 2505, dragged text prompt preset representation 2510, and tile 2515. Design board 2500 is an example of, or includes aspects of, the corresponding element described with reference to FIGS. 10-24 and 26.

In the example of FIG. 25, a set of text prompts represented by text prompt preset representation 2505 are used to respectively populate a set of tiles (including tile 2515) by dragging text prompt preset representation 2505 onto an empty tile of design board 2500. In the example, each of the tiles will include an image generated or retrieved based on the corresponding text prompt.

FIG. 26 shows an example of creating a set of additional content media items by applying a set of text prompt presets to a content media item according to aspects of the present disclosure. The example shown includes design board 2600, text prompt preset representation 2605, fifth image 2610, and additional tile 2615. Design board 2600 is an example of, or includes aspects of, the corresponding element described with reference to FIGS. 10-25.

In the example of FIG. 26, text prompt preset representation 2605 is dragged onto fifth image 2610, and a set of additional tiles (including additional tile 2615) are each respectively populated by a text prompt created by concatenating a text prompt corresponding to fifth image 2610 with a text prompt from the set of text prompts represented by text prompt preset representation 2605. In the example, each of the tiles will include an image generated or retrieved based on the corresponding text prompt.

Accordingly, a method for media processing is described. One or more aspects of the method include receiving user input indicating a variation parameter and a number of variations; identifying a first variation input and a second variation input for the variation parameter; obtaining a first media content item and a second media content item based on the first variation input and the second variation input, respectively, wherein the first media content item and the second media content item vary from each other with respect to the variation parameter; and displaying the first media content item and the second media content item in a grid comprising a grid size based on the number of variations.

In some aspects, the media content items are displayed on a design board. In some aspects, the design board comprises an infinite canvas. In some aspects, receiving the user input comprises receiving a first input indicating the variation parameter and receiving a second input indicating the number of variations. In some aspects, the user input comprises a drag-and-drop input, wherein the number of variations is based on a length of the drag-and-drop input.

Some examples of the method further include displaying a cord indicating the length of the drag-and-drop input. In some examples, a first dimension of the grid corresponds to different original content items and a second dimension of the grid corresponds to differences of the variation parameter.

In some examples, obtaining the first media content item and the second media content item includes generating a first text prompt and a second text prompt corresponding to the first variation input and the second variation input, and generating, using a generative machine learning model, the first media content item and the second media content item based on the first text prompt and the second text prompt, respectively.

Some examples of the method further include receiving an additional user input indicating an additional variation parameter, wherein rows of the grid correspond to differences of the variation parameter and columns of the grid correspond to differences of the additional variation parameter.

In some aspects, identifying the first variation input and the second variation input comprises selecting a first random seed and a second random seed. In some aspects, identifying the first variation input and the second variation input comprises identifying a first style variation and a second style variation based on the variation parameter and the number of variations. In some aspects, the plurality of style variations is selected from a predetermined set of style variations. In some aspects, the variation parameter comprises a temporal parameter and the plurality of media items corresponds to a temporal progression. In some aspects, generating the plurality of variation inputs comprises selecting a plurality of discrete values for the variation parameter from a continuous range based on the number of variations.

Some examples of the method further include generating the plurality of media content items using a generative machine learning model that takes the variation parameter as input. Some examples of the method further include generating the plurality of media content items by algorithmically modifying the media content item based on the variation parameter.

Some examples of the method further include retrieving a plurality of media content items based on the plurality of variation inputs, wherein each of the plurality of variation inputs comprises a different search query. Some examples of the method further include receiving an additional user input identifying one of the plurality of media content items as a favorite. Some examples further include storing a favorite attribute for the identified one of the plurality of media content items.

In some examples, obtaining the first media content item and the second media content item comprises generating a first search query and a second search query, and retrieving the first media content item and the second media content item from a database based on the first search query and the second search query, respectively.

A method for media processing is described. One or more aspects of the method include receiving user input indicating a variation parameter and a number of variations for a media content item; identifying a first variation input and a second variation input for the variation parameter; generating, using an image generation model, a first media content item and a second media content item based on the first variation input and the second variation input, respectively, wherein the first media content item and the second media content item vary from each other with respect to the variation parameter; and displaying the first media content item and the second media content item based on the number of variations

A method for media processing is described. One or more aspects of the method include receiving a prompt; generating, using a generative machine learning model, an image based on the prompt; displaying the image in a tile of a canvas; receiving a variation mode input from a user; and generating, using the generative machine learning model, an additional image according to the variation mode input.

In some aspects, the prompt comprises a text prompt. In some aspects, the generative machine learning model comprises a diffusion model. In some aspects, the canvas comprises an infinite canvas. In some aspects, the variation mode comprises a seed variation mode, a word replacement mode, or a random style mode.

Some examples of the method further include displaying a variation handle user interface in response to the variation mode input. Some examples further include receiving, by the variation handle user interface, a click-and-drag input, wherein the click-and-drag input moves the variation handle user interface to an additional tile of the canvas. Some examples further include receiving, by the variation handle user interface, a release input. Some examples further include displaying, in response to the release input, the additional image in the additional tile.

In some aspects, the click-and-drag input moves the variation handle user interface to a second additional tile of the canvas. In some examples, the method, apparatus, non-transitory computer readable medium, and system further include displaying, in response to the release input, a second additional image in the second additional tile.

Some examples of the method further include displaying, in response to the click-and-drag input and in the tile, text describing a variation corresponding to the variation mode input. Some examples further include generating, using the generative machine learning model, the additional image according to the variation.

Some examples of the method further include displaying, in response to the variation mode input and in an additional tile adjacent to the tile, text describing a parameter step. Some examples further include generating, using the generative machine learning model, the additional image based on the parameter step. Some examples further include displaying, in the additional tile, the additional image.

Some examples of the method further include displaying a parameter stepper user interface. Some examples further include receiving, via the parameter stepper user interface, a parameter step input to obtain the parameter step. Some examples further include receiving, via the parameter stepper user interface, a generate image input. Some examples further include generating, using the generative machine learning model, the additional image in response to the generate image input. In some aspects, the parameter step input comprises an input to a slider element of the parameter stepper user interface.

Some examples of the method further include displaying, in response to the variation mode input and in an additional tile adjacent to the tile, text describing a parameter step. Some examples further include generating, using the generative machine learning model, the additional image based on the parameter step. Some examples further include displaying, in the additional tile, the additional image.

Some examples of the method further include displaying, in response to the variation mode input and in an additional tile adjacent to the tile, text describing a parameter step. Some examples further include generating, using the generative machine learning model, the additional image based on the parameter step. Some examples further include displaying, in the additional tile, the additional image.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Machine Learning Model Training

FIG. 27 shows an example of a flow diagram depicting an algorithm as a step-by-step procedure for training a machine learning model according to aspects of the present disclosure. In some embodiments, the procedure 2700 describes an operation of the training component 3025 described for configuring the machine learning model 3020 as described with reference to FIG. 30. The procedure 2700 provides one or more examples of generating training data, use of the training data to train a machine-learning model, and use of the trained machine-learning model to perform a task.

To begin in this example, a machine-learning system collects training data (block 2702) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2704) to a type of task for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 2706). Initialization of the machine-learning model includes selecting a model architecture (block 2708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2710). The loss function is utilized to measure a difference between an output of the machine-learning model (i.e., predictions) and target values (e.g., as expressed by the training data) to be used to train the machine-learning model. Additionally, an optimization algorithm is selected (2712) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2714) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2718) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2720), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2720), the procedure 2700 continues training of the machine-learning model using the training data (block 2718) in this example.

If the stopping criterion is met (“yes” from decision block 2720), the trained machine-learning model is then utilized to generate an output based on subsequent data (block 2722). The trained machine-learning model, for instance, is trained to perform a task as described above and therefore once trained is configured to perform that task based on subsequent data received as an input and processed by the machine-learning model.

FIG. 28 shows an example of a method 2800 training a diffusion model according to aspects of the present disclosure. In some embodiments, the method 2800 describes an operation of the training component 3025 described for configuring an image generation model included in the machine learning model 3020 as described with reference to FIG. 30. The method 2800 represents an example for training a reverse diffusion process as described above with reference to FIG. 4. In some examples, these operations are performed by a system including a processor executing a set of codes to control functional elements of an apparatus, such as the guided diffusion model described in FIG. 4.

Additionally or alternatively, certain processes of method 2800 may be performed using special-purpose hardware. Generally, these operations are performed according to the methods and processes described in accordance with aspects of the present disclosure. In some cases, the operations described herein are composed of various substeps, or are performed in conjunction with other operations.

At operation 2805, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 2810, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 2815, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 2820, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 2825, the system updates parameters of the model based on the comparison. For example, parameters of a U-Net may be updated using gradient descent. Time-dependent parameters of the Gaussian transitions can also be learned.

### Computing Apparatus

FIG. 29 shows an example of a computing device 2900 according to aspects of the present disclosure. The computing device 2900 may be an example of the computing apparatus 3000 described with reference to FIG. 30. In one aspect, computing device 2900 includes processor(s) 2905, memory subsystem 2910, communication interface 2915, I/O interface 2920, user interface component(s) 2925, and channel 2930.

In some embodiments, computing device 2900 is an example of, or includes aspects of the image generation model of FIG. 4. In some embodiments, computing device 2900 includes one or more processors 2905 that can execute instructions stored in memory subsystem 2910 to perform image generation.

According to some aspects, computing device 2900 includes one or more processors 2905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2915 operates at a boundary between communicating entities (such as computing device 2900, one or more user devices, a cloud, and one or more databases) and channel 2930 and can record and process communications. In some cases, communication interface 2915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2920 is controlled by an I/O controller to manage input and output signals for computing device 2900. In some cases, I/O interface 2920 manages peripherals not integrated into computing device 2900. In some cases, I/O interface 2920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2920 or via hardware components controlled by the I/O controller.

According to some aspects, user interface component(s) 2925 enable a user to interact with computing device 2900. In some cases, user interface component(s) 2925 include an audio device, such as an external speaker system, an external display device such as a display screen, an input device (e.g., a remote-device interfaced with a user interface directly or through the I/O controller), or a combination thereof. In some cases, user interface component(s) 2925 include a GUI.

FIG. 30 shows an example of a computing apparatus 3000 according to aspects of the present disclosure. Computing apparatus 3000 may include an example of, or aspects of, the guided diffusion model described with reference to FIG. 4 and the U-Net described with reference to FIG. 5. In some embodiments, computing apparatus 3000 includes processor unit 3005, memory unit 3010, generative algorithm 3015, machine learning model 3020, training component 3025, media content component 3030, user interface 3035, and I/O module 3040. Training component 3025 updates parameters of the machine learning model 3020 stored in memory unit 3010. In some examples, training component 3025 is located outside the computing apparatus 3000.

Processor unit 3005 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 3005 is configured to operate a memory array using a memory controller. In other cases, a memory controller is integrated into processor unit 3005. In some cases, processor unit 3005 is configured to execute computer-readable instructions stored in memory unit 3010 to perform various functions. In some aspects, processor unit 3005 includes special purpose components for modem processing, baseband processing, digital signal processing, or transmission processing. According to some aspects, processor unit 3005 comprises one or more processors described with reference to FIG. 29.

Memory unit 3010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 3005 to perform various functions described herein.

In some cases, memory unit 3010 includes a basic input/output system (BIOS) that controls basic hardware or software operations, such as an interaction with peripheral components or devices. In some cases, memory unit 3010 includes a memory controller that operates memory cells of memory unit 3010. For example, the memory controller may include a row decoder, column decoder, or both. In some cases, memory cells within memory unit 3010 store information in the form of a logical state. According to some aspects, memory unit 3010 is an example of the memory subsystem 2910 described with reference to FIG. 29.

According to some aspects, computing apparatus 3000 uses one or more processors of processor unit 3005 to execute instructions stored in memory unit 3010 to perform functions described herein. For example, the computing apparatus 3000 may receive user input indicating a variation parameter and a number of variations; identify a first variation input and a second variation input for the variation parameter; obtain a first media content item and a second media content item based on the first variation input and the second variation input, respectively, where the first content item and the second media content item vary from each other with respect to the variation parameter; and display the first media content item and the second media content item in a grid comprising a grid size based on the number of variations.

In one aspect, memory unit 3010 includes generative algorithm 3015. According to some aspects, generative algorithm 3015 is implemented as software stored in memory unit 3010 and executable by processor unit 3005, as firmware, as one or more hardware circuits, or as a combination thereof. According to some aspects, generative algorithm 3015 comprises generative parameters stored in memory unit 3010.

According to some aspects, generative algorithm 3015 can be used to identify a first variation input and a second variation input for the variation parameter. In some examples, generative algorithm 3015 generates a first text prompt variation and a second text prompt corresponding to the first variation input and the second variation input. In some aspects, generating the set of variation inputs includes identifying a first style variation and a second style variation based on the variation parameter and the number of variations. In some aspects, the first style variation and the second style variation are selected from a predetermined set of style variations.

In some aspects, identifying the first variation input and the second variation input includes selecting a set of discrete values for the variation parameter from a continuous range based on the number of variations. In some examples, generative algorithm 3015 generates the first media content item and the second media content item by algorithmically modifying an original media content item based on the variation parameter. In some aspects, identifying the first variation input and the second variation input comprises selecting a first random seed and a second random seed.

The memory unit 3010 may include a machine learning model 3020 trained to generate the first media content item and the second media content item. In some embodiments, machine learning model 3020 takes the variation parameter as input. In some embodiments, machine learning model 3020 generates the first media content item and the second media content item based on the first variation input and the second variation input, respectively, where the first media content item and the second media content item vary from each other with respect to the variation parameter. For example, after training, the machine learning model 3020 may perform inferencing operations as described with reference to FIGS. 3 and 4 to generate the first media content item and the second media content item.

In some embodiments, the machine learning model 3020 is an artificial neural network (ANN) such as the guided diffusion model described with reference to FIG. 4 and the U-Net described with reference to FIG. 5. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 3020 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 3025 may train machine learning model 3020. For example, parameters of machine learning model 3020 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 27 and 28). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, machine learning model 3020 can be used to make predictions on new, unseen data (i.e., during inference).

According to some aspects, machine learning model 3020 is omitted from computing apparatus 3000. According to some aspects, machine learning model 3020 comprises an image generation machine learning model trained to generate a synthetic image. According to some aspects, machine learning model 3020 comprises a generative machine learning model trained to generate a media content item. For example, machine learning model 3020 comprises one or more of a convolutional neural network (CNN), a variational autoencoder (VAE), a generative adversarial network (GAN), a diffusion model, or any other ANN architecture suitable for generating a synthetic image or other media content item.

A CNN is a class of ANN that is commonly used in computer vision or image classification systems. In some cases, a CNN may enable processing of digital images with minimal pre-processing. A CNN may be characterized by the use of convolutional (or cross-correlational) hidden layers. The convolutional layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During a training process, the filters may be modified so that the modified filters activate upon detecting a particular feature within the input.

A VAE is an ANN that learns to encode and decode images. In some cases, a VAE comprises an encoder network that maps an input image to a lower-dimensional latent space and a decoder network that generates a new image from the latent space representation. A VAE can generate different images by sampling different points in the latent space.

A GAN is class of ANN in which two neural networks (e.g., a generator and a discriminator) are trained based on a contest with each other. For example, the generator learns to generate a candidate by mapping information from a latent space to a data distribution of interest, while the discriminator distinguishes the candidate produced by the generator from a true data distribution of the data distribution of interest. The training objective of the generator is to increase an error rate of the discriminator by producing novel candidates that the discriminator classifies as “real” (e.g., belonging to the true data distribution). Therefore, given a training set, the GAN learns to generate new data with similar properties as the training set.

A GAN may be trained via supervised learning, semi-supervised learning, unsupervised learning, or reinforcement learning. In some cases, a GAN can be guided by a prompt (such as a text prompt) such that the output of the GAN includes, to some degree, content indicated by the prompt.

A diffusion model is a class of ANN that is trained to generate an image by learning an underlying probability distribution of the training data that allows the model to iteratively refine the generated image using a series of diffusion steps. In some cases, a reverse diffusion process of the diffusion model starts with a noise vector or a randomly initialized image. In each diffusion step of the reverse diffusion process, the model applies a sequence of transformations (such as convolutions, up-sampling, down-sampling, and non-linear activations) to the image, gradually “diffusing” the original noise or image to resemble a real sample.

During the reverse diffusion process, the diffusion model estimates the conditional distribution of the next image given the current image (for example, using a CNN or a similar architecture). In some cases, a reverse diffusion process can be guided by a prompt (such as a text prompt) such that the output of the reverse diffusion process includes, to some degree, content indicated by the prompt.

According to some aspects, the diffusion model implements a reverse diffusion process (such as the reverse diffusion process described with reference to FIGS. 4 and 9). In some cases, machine learning model 3020 includes a U-Net (such as a U-Net described with reference to FIG. 6).

According to some aspects, machine learning model 3020 comprises a language generation model. In some embodiments, the language generation model comprises one or more ANNs trained to generate text. In some embodiments, the language generation model comprises a large language model (LLM) comprising one or more transformers.

According to some aspects, media content component 3030 obtains the first media content item and the second media content item based on the first variation input and the second variation input, respectively, where the first media content item and the second media content item vary from each other with respect to the variation parameter. In some examples, media content component 3030 generates a first search query and a second search query and retrieves the first media content item and the second media content item from a database based on the first search query and the second search query, respectively. In some examples, media content component 3030 stores a favorite attribute for an identified one of the first media content item and the second media content item.

According to some aspects, media content component 3030 is implemented as software stored in memory unit 3010 and executable by processor unit 3005, as firmware, as one or more hardware circuits, or as a combination thereof.

According to some aspects, user interface 3035 is implemented as software stored in memory unit 3010 and executable by processor unit 3005. In some cases, user interface 3035 is provided on a user device by computing apparatus 3000. In some cases, user interface 3035 is implemented as a graphical user interface (GUI), a text-based interface, or a combination thereof. In some cases, user interface 3035 is configured to display elements described herein, such as a design board, various user interface elements, a media content item, an additional media content item, etc.

According to some aspects, user interface 3035 receives user input indicating a variation parameter and a number of variations. In some examples, user interface 3035 displays the first media content item and the second media content item in a grid including a grid size based on the number of variations.

In some aspects, the first media content item and the second media content item are displayed on a design board. In some aspects, the design board includes an infinite canvas. In some aspects, receiving the user input includes receiving a first input indicating the variation parameter and receiving a second input indicating the number of variations. In some aspects, the user input includes a drag-and-drop input, where the number of variations is based on a length of the drag-and-drop input. In some examples, user interface 3035 displays a cord indicating the length of the drag-and-drop input.

In some examples, a first dimension of the grid corresponds to different original content items and a second dimension of the grid corresponds to differences of the variation parameter. In some examples, user interface 3035 receives an additional user input indicating an additional variation parameter, where rows of the grid correspond to differences of the variation parameter and columns of the grid correspond to differences of the additional variation parameter.

In some aspects, the variation parameter includes a temporal parameter and the set of media items corresponds to a temporal progression. In some examples, user interface 3035 receives an additional user input identifying one of the first media content item and the second media content item as a favorite.

I/O module 3040 receives inputs from and transmits outputs of computing apparatus 3000 to other devices or users. For example, I/O module 3040 receives inputs for machine learning model 3020 and transmits outputs of machine learning model 3020. According to some aspects, I/O module 3040 is an example of the I/O interface 2920 described with reference to FIG. 29.

Accordingly, a system and apparatus for media processing are described. One or more aspects of the system and apparatus include a memory component; and a processing device coupled to the memory component, the processing device configured to perform operations comprising receiving user input indicating a variation parameter and a number of variations; identifying a first variation input and a second variation input for the variation parameter; obtaining a first media content item and a second media content item based on the first variation input and the second variation input, respectively, wherein the first media content item and the second media content item vary from each other with respect to the variation parameter; and displaying the first media content item and the second media content item in a grid comprising a grid size based on the number of variations.

According to some aspects, the system and apparatus further comprise a generative machine learning model comprising machine learning parameters stored in the memory component, the generative machine learning model trained to generate the first media content item and the second media content item. According to some aspects, the system and apparatus further comprise a user interface configured to display the first media content item and the second media content item.

The description and drawings described herein represent example configurations and do not represent all the implementations within the scope of the claims. For example, the operations and steps may be rearranged, combined, or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for media processing, comprising:
obtaining a variation parameter and a number of variations;
identifying a first variation input and a second variation input for the variation parameter;
obtaining a first media content item and a second media content item based on the first variation input and the second variation input, respectively, wherein the first media content item and the second media content item vary from each other with respect to the variation parameter; and
displaying the first media content item and the second media content item in a grid comprising a grid size based on the number of variations.

2. The method of claim 1, wherein obtaining the variation parameter and the number of variations comprises:
receiving a first user input indicating the variation parameter; and
receiving a second user input indicating the number of variations.

3. The method of claim 1, wherein obtaining the number of variations comprises:
obtaining a drag-and-drop input, wherein the number of variations is based on a length of the drag-and-drop input.

4. The method of claim 3, further comprising:
displaying a cord indicating the length of the drag-and-drop input.

5. The method of claim 1, wherein:
a first dimension of the grid corresponds to different original content items and a second dimension of grid corresponds to differences of the variation parameter.

6. The method of claim 1, wherein obtaining the first media content item and the second media content item comprises:
generating a first text prompt and a second text prompt corresponding to the first variation input and the second variation input; and
generating, using a generative machine learning model, the first media content item and the second media content item based on the first text prompt and the second text prompt, respectively.

7. The method of claim 1, further comprising:
receiving an additional variation parameter, wherein rows of the grid correspond to differences of the variation parameter and columns of the grid correspond to differences of the additional variation parameter.

8. The method of claim 1, wherein identifying the first variation input and the second variation input comprises:
selecting a first random seed and a second random seed.

9. The method of claim 1, wherein identifying the first variation input and the second variation input comprises:
identifying a first style variation and a second style variation based on the variation parameter and the number of variations.

10. The method of claim 1, wherein obtaining the first media content item and the second media content item comprises:
generating a first search query and a second search query; and
retrieving the first media content item and the second media content item from a database based on the first search query and the second search query, respectively.

11. A non-transitory computer readable medium storing code for media processing, the code comprising instructions that, when executed by at least one processor, causes the at least one processor to perform operations comprising:
obtaining a variation parameter and a number of variations for a media content item;
identifying a first variation input and a second variation input for the variation parameter;
generating, using an image generation model, a first media content item and a second media content item based on the first variation input and the second variation input, respectively, wherein the first media content item and the second media content item vary from each other with respect to the variation parameter; and
displaying the first media content item and the second media content item based on the number of variations.

12. The non-transitory computer readable medium of claim 11, wherein obtaining the variation parameter and the number of variations comprises:
receiving a first user input indicating the variation parameter; and
receiving a second user input indicating the number of variations.

13. The non-transitory computer readable medium of claim 11, wherein obtaining the number of variations comprises:
receiving a drag-and-drop input, wherein the number of variations is based on a length of the drag-and-drop input.

14. The non-transitory computer readable medium of claim 13, wherein the instructions further causes the at least one processor to perform operations comprising:
displaying a cord indicating the length of the drag-and-drop input.

15. The non-transitory computer readable medium of claim 11, wherein obtaining the first media content item and the second media content item comprises:
generating a first text prompt and a second text prompt corresponding to the first variation input and the second variation input; and
generating, using the image generation model, the first media content item and the second media content item based on the first text prompt and the second text prompt, respectively.

16. The non-transitory computer readable medium of claim 11, wherein identifying the first variation input and the second variation input comprises:
selecting a first random seed and a second random seed.

17. The non-transitory computer readable medium of claim 11, wherein identifying the first variation input and the second variation input comprises:
identifying a first style variation and a second style variation based on the variation parameter and the number of variations.

18. A system for media processing, comprising:
a memory component; and
a processing device coupled to the memory component, the processing device configured to perform operations comprising:
obtaining a variation parameter and a number of variations;
identifying a first variation input and a second variation input for the variation parameter;
obtaining a first media content item and a second media content item based on the first variation input and the second variation input, respectively, wherein the first media content item and the second media content item vary from each other with respect to the variation parameter; and
displaying the first media content item and the second media content item in a grid comprising a grid size based on the number of variations.

19. The system of claim 18, further comprising:
a generative machine learning model comprising machine learning parameters stored in the memory component, the generative machine learning model trained to generate the first media content item and the second media content item.

20. The system of claim 18, further comprising:
a user interface configured to display the first media content item and the second media content item.
